(19) United States
(12) Patent Application Publication
(10) Pub. No.: US 2016/0284175 A1
(43) Pub. Date: Sep. 29, 2016

(54) Visual and Audio Warning System Including Test Ledger for Automated Door

(71) Applicants: Clayton L. Finn, South Elgin, IL (US); Daniel R. Williams, Barnesville, GA (US)

(72) Inventors: Clayton L. Finn, South Elgin, IL (US); Daniel R. Williams, Barnesville, GA (US)

(21) Appl. No.: 15/172,079

(22) Filed: Jun. 2, 2016

Related U.S. Application Data
(63) Continuation of application No. 13/531,495, filed on Jun. 22, 2012, now abandoned.
(60) Provisional application No. 61/505,240, filed on Jul. 7, 2011.

(51) Int. Cl. G08B 7/06; G06Q 50/26

(52) U.S. Cl. CPC G08B 7/06; G06Q 50/265; E05Y 2800/40

(57) ABSTRACT

A handheld wireless communicator transmits automated door test requests to a server which records test requests, results, date, time, location and door identification number. The server also sends a default email of an expired scheduled check, test or inspection and a unique handheld wireless communicator identification. The handheld wireless communicator includes GPS capabilities enabling the server to record the specific location of the handheld wireless communicator while performing tests. An ID tag is used to identify the specific door being checked, tested or inspected at the location.

### REFERENCE TO RELATED APPLICATIONS

This patent application is a continuation of application Ser. No. 13/531,495, filed on Jun. 22, 2012, which claims priority to U.S. provisional patent application entitled “Visual and Audio Warning Device Projected from Door and Portable Device with Daily Test Ledger,” having Ser. No. 61/505,240, filed on Jul. 7, 2011. Both the previously filed applications referenced immediately above in this paragraph are hereby incorporated by reference.

### BACKGROUND OF THE INVENTION

1. Field of the Invention

The present invention relates generally to visual and audio warning systems for doors, and more particularly, to a warning and safety test record system for automated, low-energy, high-energy, swing, folding, sliding, and overhead doors.

2. Description of Related Art

Automated doors are becoming more common in an increasing number of environments. For example, automated or powered overhead garage doors are generally standard in residential homes and commercial buildings. Furthermore, automated pedestrian doors are generally standard in retail locations, such as grocery stores. While automated doors both for vehicles and pedestrians provide an important convenience for home owners, customers, and business owners, automated or power operated doors also can increase the risk of injury in particular situations. For example, in nursing homes, while waiting to get into a shuttle bus, automatic doors possibly can open or close unexpectedly before a disabled or elderly person has time to move out of the way or be aware the door is moving. Similarly, customers carrying groceries or packages may be unaware an automatic door is opening or closing. Furthermore, a person entering a hospital may stop to catch their breath and be unaware that an automated door can close on them if they stand still for more than 30 seconds, and even less time, if a presence sensor on the door is adjusted incorrectly or fails to work properly.

Presence sensors currently are required to hold for a short period of time, and in the case of low energy automated doors, also commonly known as handicap doors, no detection sensor is required at all. According to ANSI 156.10 §8.1.3, presence sensors shall detect a stationary 28″ high person within the detection area for a minimum of 30 seconds. According to ANSI 156.19 for low energy operators, if a presence sensing device is not used to hold the door in the full open position, a minimal time delay of 5 seconds is required before the door begins to close, and there is no warning that the door is about to close.

The full content of the following publications and sections of the American National Standards Institute (ANSI) are hereby incorporated by reference in their entirety: ANSI 156.10—2005 Quick Reference Guide; and ANSI 156.4; ANSI 156.5; ANSI 156.10; and 156.19 as current in year 2011.

Also incorporated by reference in their entirety are the following Owners Manuals published in February 2010 by the American Association of Automatic Door Manufacturers (AAADM), located at 1300 Summer Avenue in Cleveland, Ohio 44115, for Automatic Swinging Door, Automatic Folding Door, Automatic Sliding Doors, and Low Energy Power Operated Doors.

The AAADM also published the following guide entitled “How to Perform a Daily Safety Check.” It states as follows:
Sensor Activation/Presence Detection Safety Checks
In general, start by checking the electronic sensor by walking toward the door opening at a moderate speed at various angles. The door should start opening as you approach, should swing or slide open smoothly and stop without impact. As you move slowly toward the door, it should remain open. For doors that are used for two-way traffic, you should repeat this process from the other side of the opening. Now, step out of the sensor zone or off the floor mat. After a brief time delay, the door should close. Approach the safety side of the swinging door first, then have someone else approach the activating side of the door. As long as you are in the safety area of the door, it should not open. It is recommended that you observe the traffic coming to the door and plan the traffic patterns so that people will approach the doors from straight on and not from an angle. Further, if your doors are equipped with electronic holding beams, you should cover each doorway holding the beam with your hand and stand motionless for several seconds. The door should remain open. Remove your hand and the door should close after the time delay expires. If other safety devices are being used, crouch motionless in the door opening for ten seconds. The door should not close. If the safety sensor is not working, the door may swing toward you without stopping. Exercise caution while conducting your daily checks.

Also incorporated by reference in its entirety is the ADA Accessibility Guidelines for Buildings and Facilities (ADAAG) as current in the year 2011.

Visual and audio warnings provide a warning for pedestrians, bystanders and vehicle operators. In residential condos and parking garages, it is necessary for vehicle drivers to maintain a visual awareness of what is in front of them at all times, such as pedestrians. In commercial business situations involving truck operators loading and unloading, or passing through automated doors, the truck operators need to be aware when automated doors are opening and closing. This can be difficult in situations where there is a lot of truck traffic interfering with the visibility of obstacles and warning signals, and loud operating noises that prevent truck operators from hearing audio warnings and information.

Automated doors also need to be checked frequently to confirm they are operating correctly both in the public and private sectors, and especially in areas where the individual users are particularly vulnerable, such as nursing homes, hospitals, and areas where disabled persons require access. Many people are seriously injured every year from automated doors. A large percentage of these injuries are from door sensor failures that could have been prevented by routine inspections and a better warning system. Safety inspections should be performed daily, and professional inspections are supposed to be performed annually, according to manufactures and regulatory commissions. If a door sensor for detecting people proximate to an automated door fails and there is no warning that the door is about to shut, then the automated door can close on a person unexpectedly causing serious injury.

A significant percentage of serious injuries resulting from automated door system failures include small children, elderly and disabled persons. Other individuals also commonly receive less serious injuries from automated doors opening or closing unexpectedly, when these individuals are entering or exiting through automated doors. For example, an automated door can close unexpectedly and trap small children or pinch fingers. Common locations where automated doors cause injuries include retail establishments, retirement centers, hospitals, and medical centers.

Accordingly, there exists a need for an improved automated door warning system for alerting various types of personnel who are responsible for the equipment and individual users, including elderly and disabled persons. Moreover, there exists a need for an improved automated door warning system that tracks safety inspections and alerts the responsible party when an automated door has not been checked, tested or inspected for safety in the proper allotted time.

### ASPECTS AND SUMMARY OF THE PRESENT INVENTION

In order to overcome these deficiencies in the prior art, one aspect of the present invention positions a visual warning indicator directly on an automated door so that individual users do not have to take their eyes off the specific area through which they are entering or exiting to be warned the door is closing or to use caution. Furthermore, such an improved visual warning system can be provided for a vehicle coming out of a garage and crossing a sidewalk, also for pedestrian walking in front of a condo or a parking garage.

Another aspect of the present invention locates a visual warning indicator on a portion of the door that is most likely to come in contact with individuals that use the door while the automated door is opening, remaining open, or closing.

An additional aspect of the present invention provides both a visual and an audible warning of a door about to open, while opening, when opened, about to close, and while closing.

A further aspect of the present invention alerts those responsible for maintaining the doors, using visual and auditory signals, as to whether an automated door system is current on its daily, annual, or scheduled safety checks, tests, or inspections.

An additional aspect of the present invention provides a locally or remotely security encoded ledger or data base for recording safety checks, tests and inspections that cannot be altered or accessed by unauthorized personnel.

Another aspect of the present invention provides a handheld wireless communicator for transmitting automated door test requests to a server that records door identification information, test requests, test results, test dates, test times, and identification information of the handheld wireless communicators being used by safety inspectors and end users. The handheld wireless communicator includes GPS capabilities enabling a computer server to record the specific location of the handheld wireless communicator while performing these tests.

In view of the foregoing, the present invention provides a warning system for an automated door comprising a door capable of moving between an open position and a closed position, the door having a first side with a first engagement end and a second side with a second engagement end, wherein the first and second engagement ends are adjacent to a peripheral edge when the door is in the closed position. An actuator or motor opens and closes the door. A first visual warning indicator is attached to the first engagement end of the door for visually indicating when the door is opening and closing, or about to open or close. A handheld wireless communicator transmits automated door test requests to a server which records test requests, results, date, time, location and door identification number. The server also sends a default email of an expired scheduled check, test or inspection and a unique handheld wireless communicator identification. The handheld wireless communicator includes GPS capabilities enabling the server to record the specific location of the handheld wireless communicator while performing tests. An ID tag is used to identify the specific door being checked, tested or inspected at the location.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1 is a perspective view of the interior side of an overhead garage door configured in accordance with the present invention;

FIG. 2 is a front view of the exterior side of the garage door shown in FIG. 1;

FIG. 3 is an enlarged view of an array of lights shown in FIGS. 1 and 2;

FIG. 4 illustrates a front view of the interior side of a sliding door configured in accordance with the present invention;

FIG. 5 illustrates an enlarged view of the wire track guide and the wire carrier chain shown in FIG. 4;

FIG. 6 illustrates a front view of the exterior side of a siding door shown in FIG. 4;

FIG. 7 illustrates a front view of the interior side of double sliding doors configured in accordance with the present invention;

FIG. 8 illustrates a front view of the exterior side of the double sliding doors shown in FIG. 7;

FIG. 9 illustrates a front view of the interior side of a low energy automated door configured in accordance with the present invention;

FIG. 10 illustrates a front view of the exterior side of the low energy automated door shown in FIG. 9.

FIG. 11 is a front view of the interior side of a high energy automated door configured in accordance with the present invention;

FIG. 12 is a front view of the exterior side of the high energy automated door shown FIG. 11;

FIG. 13 is a front view of an automated gate configured in accordance with the present invention;

FIGS. 14a, 14b and 14c illustrate a schematic of a universal controller configured in accordance with the present invention for the automated low energy door shown in FIGS. 9 and 10;

FIGS. 15a, 15b and 15c illustrate a schematic of a universal controller configured in accordance with the present invention for the overhead garage door in FIGS. 1 and 2;

FIGS. 16a, 16b and 16c illustrate a schematic of a universal controller configured in accordance with the present invention for the automated sliding door shown in FIGS. 4 and 6, 7, 8 and the high energy automated door shown in FIGS. 11 and 12;

FIG. 17 is a flowchart of process steps executed by the automated overhead door in accordance with the present invention;

FIG. 18 is a flowchart of the process executed by the low energy automated door in accordance with the present invention;

FIG. 19 is a flowchart of the process executed by the high energy automated door in accordance with the present invention;

FIG. 20 is a flowchart of the process executed by the sliding automated door in accordance with the present invention;

FIG. 21 is a flowchart of the process executed by the safety ledger system in accordance with the present invention;

FIG. 22 illustrates examples of displays on a smartphone device for performing daily and annual safety automated door inspections in accordance with the present invention;

FIG. 22a illustrates a flowchart for performing a daily inspection using a smartphone in accordance with a method of the present invention; and

FIG. 22b illustrates a flowchart for performing an annual inspection using a smartphone in accordance with a method of the present invention.

### DETAILED DESCRIPTION OF THE PREFERRED EMBODIMENTS

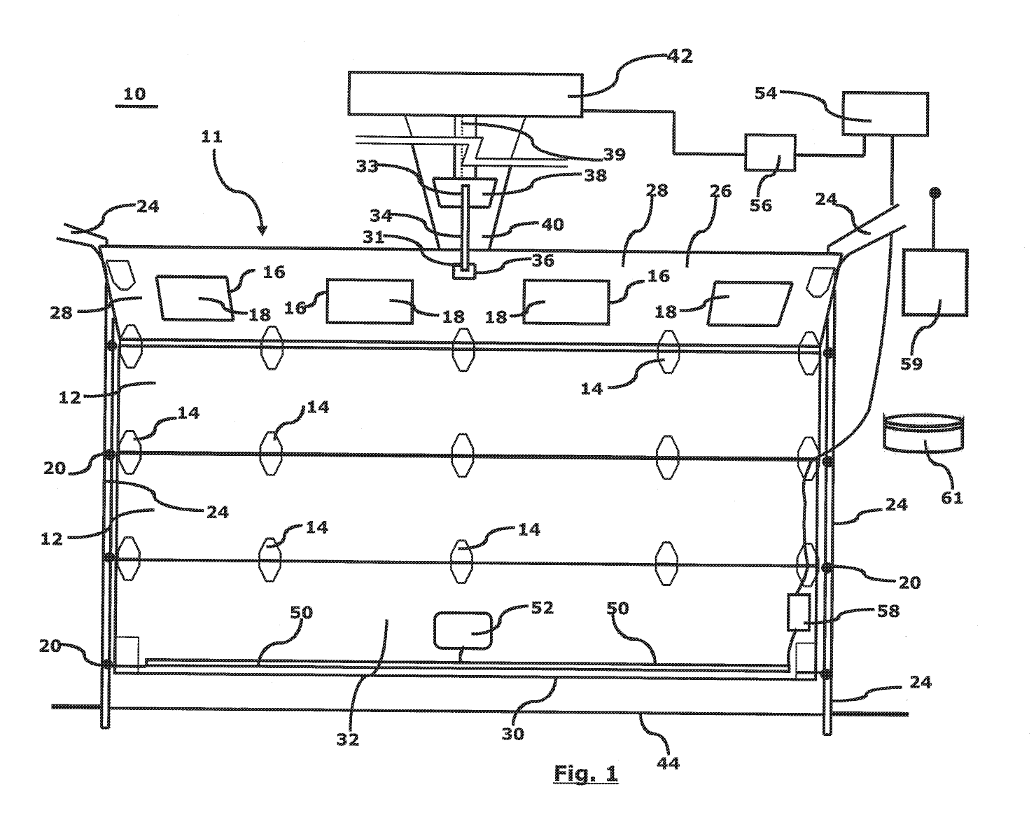

Referring now to the drawings, FIG. 1 illustrates the interior side of an overhead garage door system 10 configured in accordance with the present invention. The overhead garage door system 10 includes a garage door 11 having multiple panels 12 connected together by hinges 14. The panels 12 of the overhead garage door 11 can be constructed of wood, steel, aluminum, or other various materials. The overhead garage door 11 also can include cut out sections 16 for holding windows 18. The panels 12 include multiple rollers 20 installed in the hinges 14 on opposing ends of the panels 12 located proximate the hinges 14. The rollers 20 are located within a track 24 which the panels 12 of the overhead garage door 11 follow when the panels 12 are raised and lowered to open and close the overhead garage door 11.

A top end 26 of the overhead garage door 11 is located on an upper panel 28 of the panels 12. A bottom end 30 of the garage door 11 is located on a lower panel 32 of the panels 12. A first end 31 of an arm 34 is rotatably mounted to a plate 36 which is connected to the upper panel 28. A second end 33 of the arm 34 is rotatably mounted at a pivot point on a drawbar carriage 38. The drawbar carriage 38 is connected to a chain 39 that travels along a drawbar track 40. The drawbar chain 39 is connected to an operator, actuator or motor 42 that drives the chain 39 to move the drawbar carriage 38, which in turn raises and lowers the panels 12 of the overhead garage door 11.

The bottom end 30 of the lower panel 32 functions as a first engagement end of the overhead garage door 11 which comes into contact with a peripheral edge 44 when the overhead garage door 11 is closed. In FIG. 1, the peripheral edge 44 is the ground or the floor. In other embodiments, which are illustrated in other figures in this application, the peripheral edge can be a door frame, a wall, another connecting door, or a gate latch or gate frame, depending upon how the door operates to open or close.

In accordance with the present invention, FIG. 1 illustrates a visual warning indicator 50 attached to a first engagement end 30 on a first side of the garage door 11 which is adjacent to the peripheral edge 44 when the garage door 11 is closed. The visual warning indicator 50 shown in FIG. 1 is a preferably a horizontal array of lights attached to the bottom end 30 of lower panel 32. The array of lights 50 can be incandescent or LED lights of any color, but are preferably a combination of red and green lights to signal when the garage door 11 is opening, open, about to close, closing, and closed. The array of lights 50 is preferably connected to the first side or inner side of the lower panel 32, and not the bottom of the panel 32, to prevent the array of lights 50 from being damaged when the overhead garage door 11 is closed.

In accordance with a further aspect of the present invention, an audible warning device 52, such as a speaker, sound port or an annunciator, is attached to the overhead garage door 11, preferably on the first or interior side of the lower panel 32 adjacent to bottom end 30. The audible warning device 52 provides a spoken message to alert vehicle operators and pedestrians that the overhead garage door 11 is opening, opened, about to close, closing, and closed.

A universal controller 54 also is shown for controlling the first visual warning indicator 50 and the audible warning device 52. The universal controller 54 determines when and which colored lights of the visual warning indicator 50 are activated. The universal controller 54 also controls when the audible warning device 52 is activated and what statements are announced. A power source 56 is electrically connected the universal controller 54 and to the actuator 42. An electrical box or connector box 58 is located on the lower panel 32 to provide electrical connections for the visual warning indicator 50 and the audible warning device 52, and electrical connections for additional components. A wireless transmitter/receiver 59 is included for transmitting signals to open or close the door 11, receiving warning signals that the door 11 is opening, transmitting door safety inspection data signals to a local or remote server and data storage device 61, and/or receiving warning signals that a safety inspection of the door 11 is past door.

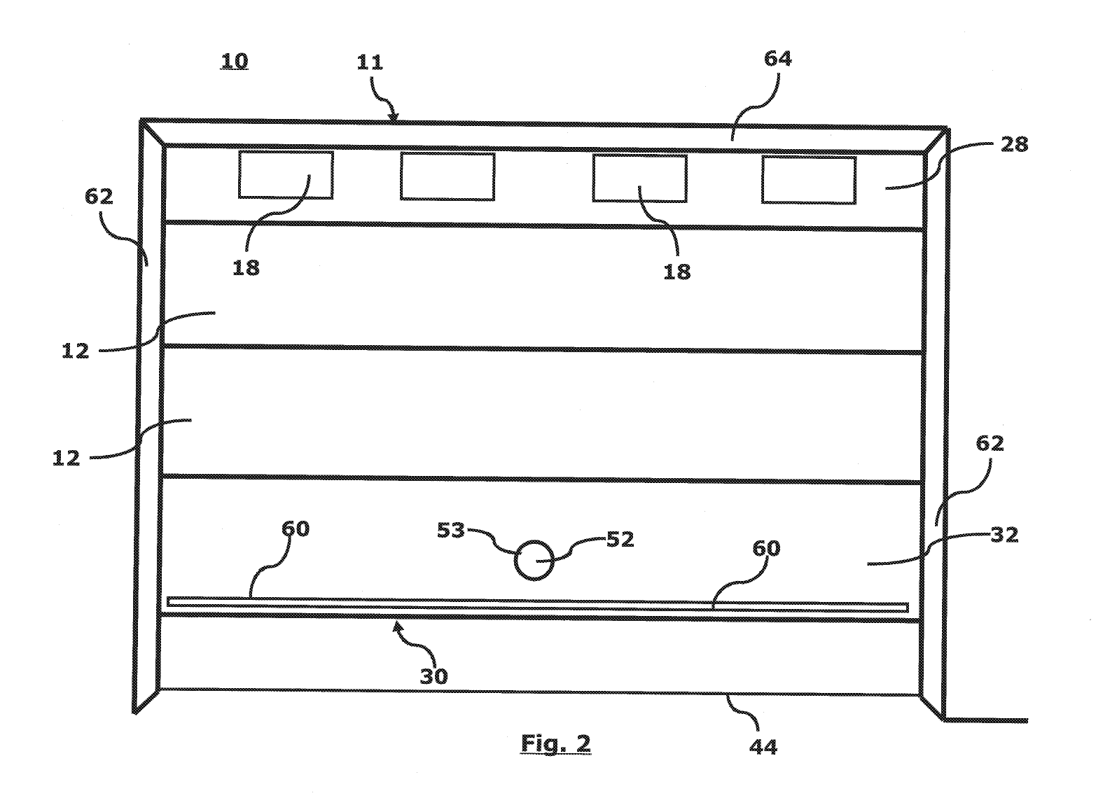

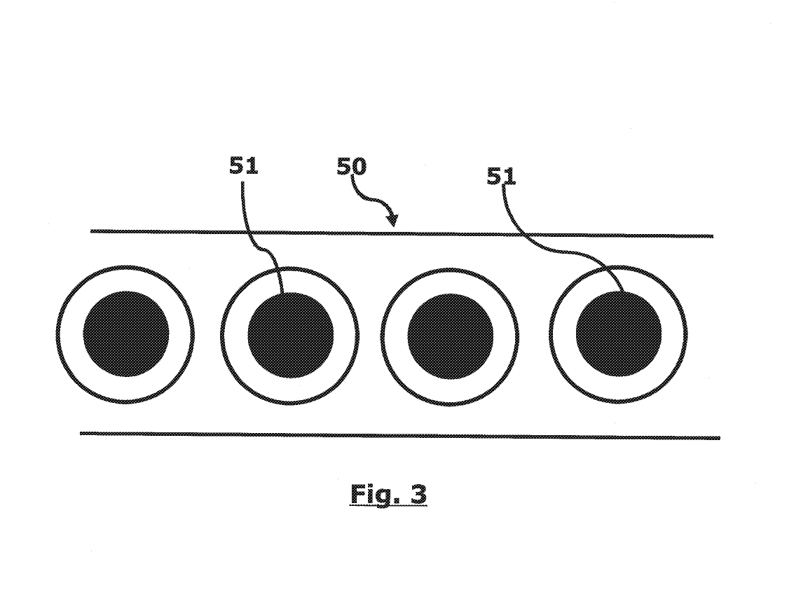

FIG. 2 illustrates an exterior side or second side of the panels 12 of the overhead garage door 11 shown in FIG. 1. The first side and second side of the panels 12 of the overhead garage door 11 refer to the interior and exterior sides, wherein the first side can refer to either the interior or the exterior side of the overhead garage door 11, and the second side would be the opposite side. Windows 18 are located in the upper panel 28 as shown in FIG. 1. Adjacent to the panels 12 are sidewalls 62 and an upper wall 64. The peripheral edge 44 is provided by the floor. An aperture 53 in lower panel 32 provides access for the audio warning device 52 which also is illustrated in FIG. 1.

In accordance with a further aspect of the present invention, a second visual warning indicator 60 is attached to the exterior side of the lower panel 32 adjacent to the bottom edge 30. Similar to the first visual warning indicator 50. the second visual warning indicator 60 is preferably not located on the bottom of the lower panel 32 in order to prevent the second visual warning indicator 60 from being damaged when the overhead garage door 11 is closed. Additionally, like the first visual warning indicator 50, the second visual warning indicator 60 includes an array of lights that is activated and changes colors to indicator when the overhead garage door 11 is opening, fully open, about to close, closing, and closed.

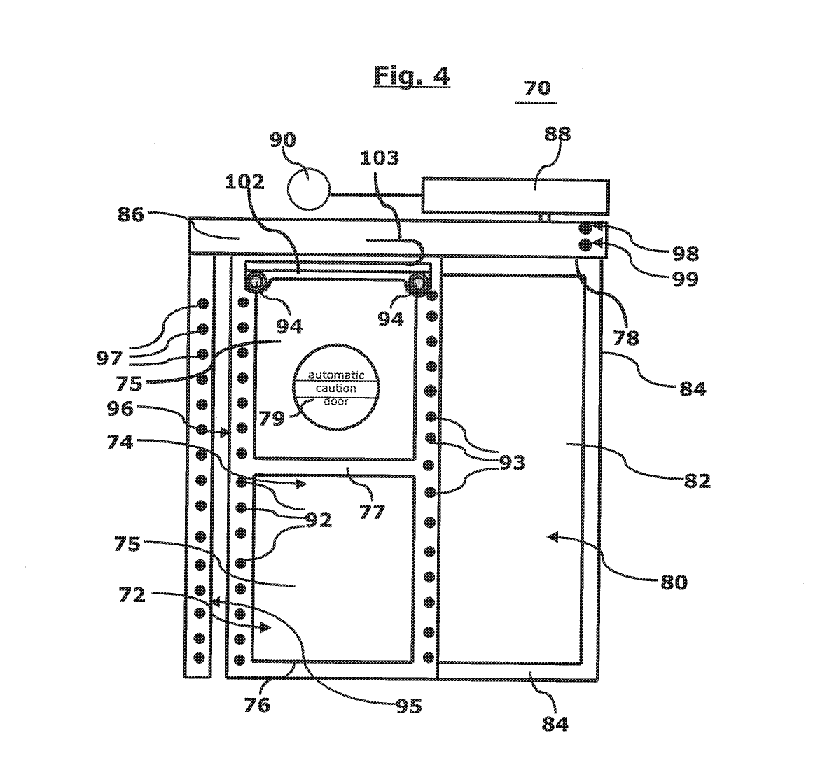

FIG. 3 illustrates and enlarged view of a portion of the first visual warning indicator 50. Incandescent lights or LEDs 51 are shown in the first visual warning indicator 50. The lights or LEDs 51 can all be the same or multiple colors for indicating various stages of the overhead garage door 11 during the opening and closing process. An example of an LED light array is LED light strip WFLS-RGB and WFLS-W sold by Super Bright LEDs, Inc. in St. Louis, Mo.

FIG. 4 shows a front view of an interior side 72 of a sliding door 74 within a sliding door system 70 configured in accordance with the present invention. The sliding door 74 includes an outer frame 76 that contains transparent glass or Plexiglas® 75. An inner frame 77 separates two pieces of glass 75 within the sliding door 74. The sliding door 74 is suspended by and travels along a track 78 to enable the sliding door 74 to move between a closed and an open position. The position illustrated in FIG. 4 is the almost closed position of the sliding door 74. When the sliding door 74 is in a closed position it covers at least a portion of the area 80, which can be glass or Plexiglas® 82 enclosed by a frame 84. In other embodiments the area 80 can be a solid wall. An “Automatic Caution Door” door warning sign 79 is located on the glass 75 in the sliding door 74.

An automatic door motor operator 86 functions as an actuator to move the sliding door 74 between the open and closed positions. The actuator 86 is controlled by a universal monitor and controller 88. A hazardous gas sensor 90 is connected to the universal monitor and controller 88. The hazardous gas sensor 90 can be model number YET703 sold by Shenzhen Chuangyao Technology Co.

In accordance with the present invention, an array of lights 92 is located upon an engagement end 96 of the sliding door 74 which comes in contact with a peripheral edge 95 when the sliding door 74 is closed. Here the peripheral edge is a wall 95. A second plurality of lights 93 is located on the opposing end of the sliding door 74. When the sliding door 74 is opening, the array of lights 92,93 are solid, and when the sliding door is about to close, the array of lights 92, 93 are flashing, and when closing, the array of lights 92,93 solid. When the sliding door 74 is about to move or in motion, the array of lights 92,93 preferably are solid red, and when the sliding door is stationary, the array of lights 92, 93 preferably are flashing green or remain constantly lit green. In another embodiment of the invention, an array of lights 97 can be located on the peripheral edge 95, which in FIG. 4 is a wall or door frame. The array of lights 97 can follow the signaling pattern of the array of lights 92,92 on the sliding door 74.

The sliding door 74 also includes audio warning devices 94, which are located on the upper portion of the sliding door 74. The audio warning devices 94 are preferably speakers, such as the ELK73, which are sold by ELK Products, Inc. in Hildebran, N.C. The audio warning devices 94 announce when the sliding door 74 is about to move or in motion, stating something like, “Caution, the door is about to close,” “Caution, the door is closing,” and “Caution, the door is opening.”

The sliding door system 70 further includes an audio/visual safety check, test status signal indicator 98 for alerting those responsible for the equipment of needed testing, and an audio/visual (A/V) professional inspection status signal indicator 99 for indicating a needed scheduled professional inspection. The audio/visual safety test status signal indicator 98 is preferably a small light with a small audible buzzer that is activated in when the sliding door 74 is behind on its daily testing status. For example, the light on the A/V safety test status signal indicator 98 can emit flashes continuously when the sliding door 74 is behind on it daily testing status, and the audio buzzer on the A/V safety test status signal indicator 98 can emit a buzz sound. If the sliding door 74 is behind on its professional inspection status, the light on the A/V/ professional inspection status signal indicator 99 can emit a flashing light, and the audio buzzer on the A/V professional inspection status signal indicator 99 can emit a buzzing sound, similar to A/V/ safety test status signal indicator 98. The audio test status indicator devices 98, 99 include both audio and a visual status indicator, such as model AD116-22DS/MFS from Zhejiang Gaoqiao Electronics Co. These A/V signals let those responsible for the equipment and all observers know that something is wrong and needs to be attended to and corrected. The reset scheduled status alerts for tests, checks and inspections can be reset with an optional button, such model HMI XBTGT1335 sold by Schneider Electric Co. or a CPU with Ethernet access and a Cana Kit 4 port USB relay controller with 6 channel I/O interface to reset.

The sliding door 74 includes a wire track system 100 having a wire track guide 102 and a wire carrier chain 103 for providing power and control signals to the visual and audio warning systems 92,93,94 on the door 74.

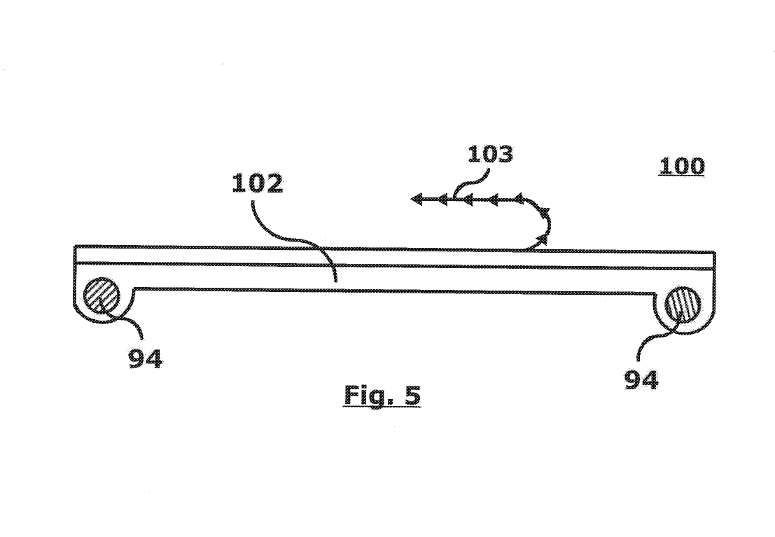

FIG. 5 is an enlarged view of the wire track system 100 of the sliding door 74 shown in FIG. 4. The wire track system 100 includes the wire track guide 102 for receiving the wire carrier chain 103. The wire carrier chain 103 carries an electrical wire for providing power and signals to the arrays of lights 92,93 and the speakers 94 on the sliding door 74.

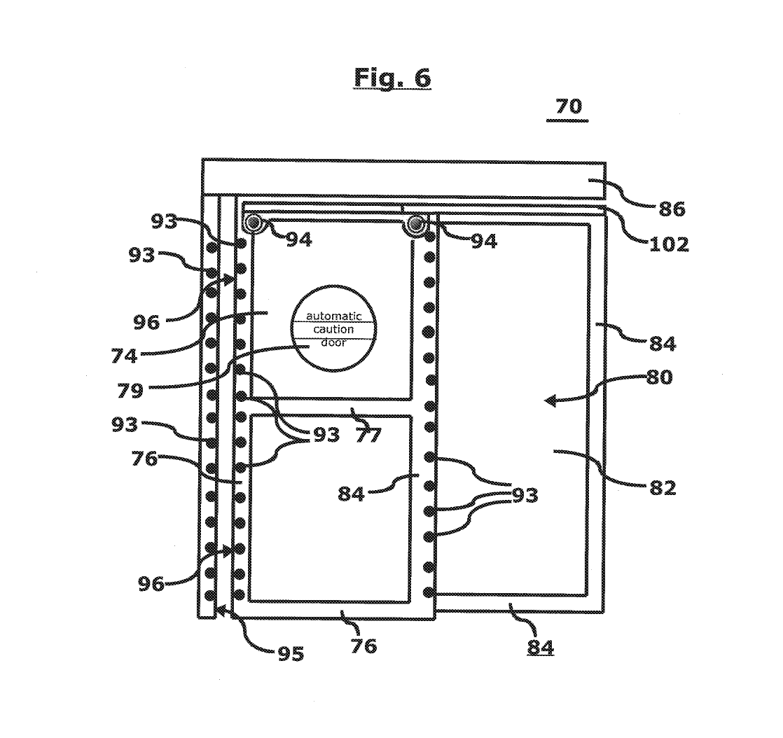

FIG. 6 is a front view of the exterior side of the sliding door 74 shown in FIG. 4. Illustrated are the actuator 86, wire track guide 102, and an exterior array of lights 93 and speakers 94. An exterior “Automatic Caution Door” or any required sign 79 also is illustrated. The frame 76 containing glass 74 is shown. The engagement end 96 is almost in contact with the peripheral edge, which here is illustrated as the door frame or side wall 95.

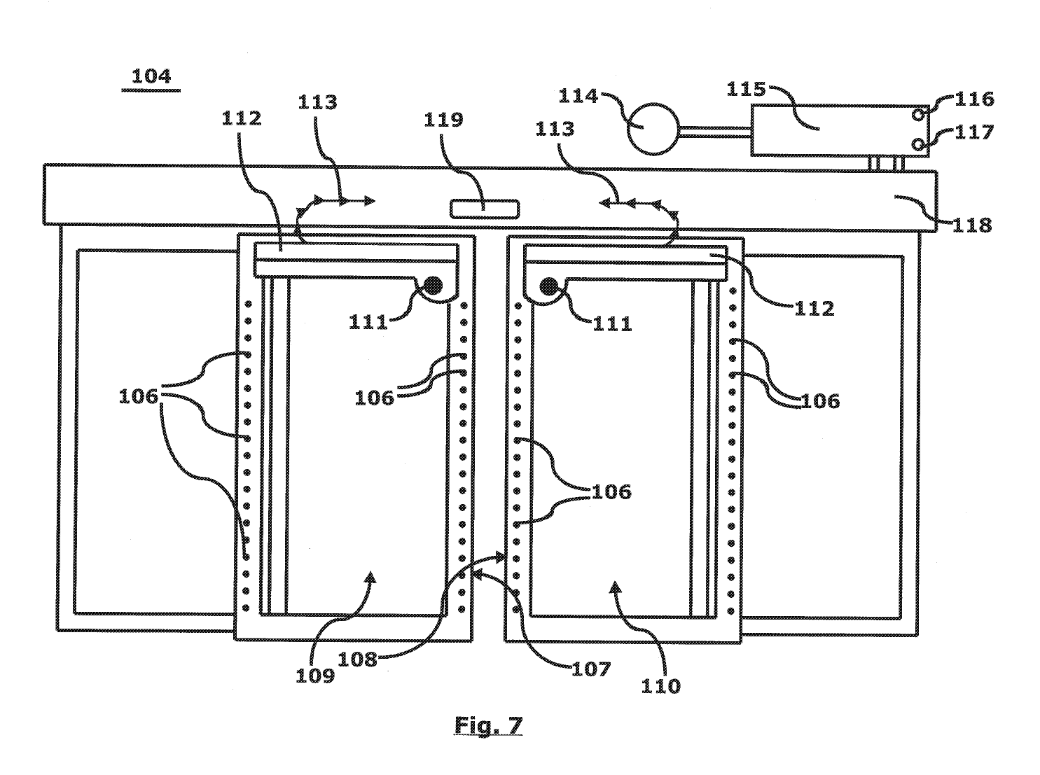

FIG. 7 illustrates a front view of the interior side of a sliding double-door system 104 configured in accordance with the present invention. A pair of sliding doors 109, 110 are illustrated each having an array of lights 106 on opposing ends of the doors. Engagement ends 107, 108 on sliding doors 109, 110, respectively, come in contact with each other when the sliding doors 109, 110 are in the closed position. Here, the sliding doors 109, 110 are illustrated as being almost closed. Speakers 111 are included on each of the sliding doors 109, 110.

Similar to the sliding door in FIGS. 4 and 6, the pair of sliding doors 109, 110 includes a wire track 112 on each door 109, 110 for receiving a wire carrier chain 113. The wire carrier chain 113 carries an electrical wire for providing power and signals to the array of lights 106 and the speakers 111 on the sliding doors 109, 110. A hazardous gas detector 114 is connected to a universal controller 115. An audio/visual safety test status device 116 for daily safety test status and an audio/visual safety test status device 117 for annual or scheduled inspections is located on the universal controller 115. The audio/visual test status devices 116, 117 function similar to the audio/visual test status devices 98, 99 shown in FIG. 4. The audio/visual test status devices 116, 117 can be part #AD116-22DS/MFS sold by Zhejiang Gaoqiao Electronics Co. The array of lights 106 and speakers 111, and the visual safety test status devices 116, 117 all function similar to the similar devices in disclosed in FIGS. 4 and 6.

An electric motor 118 functions as an actuator. A presence and active sensor 119 is included to detect people proximate to the sliding doors 109, 110, and for preventing the doors 109, 110 from closing on people. A presence and active sensor that could be used is the I-One activation and present sensor sold by Optex in Torrence Ca.

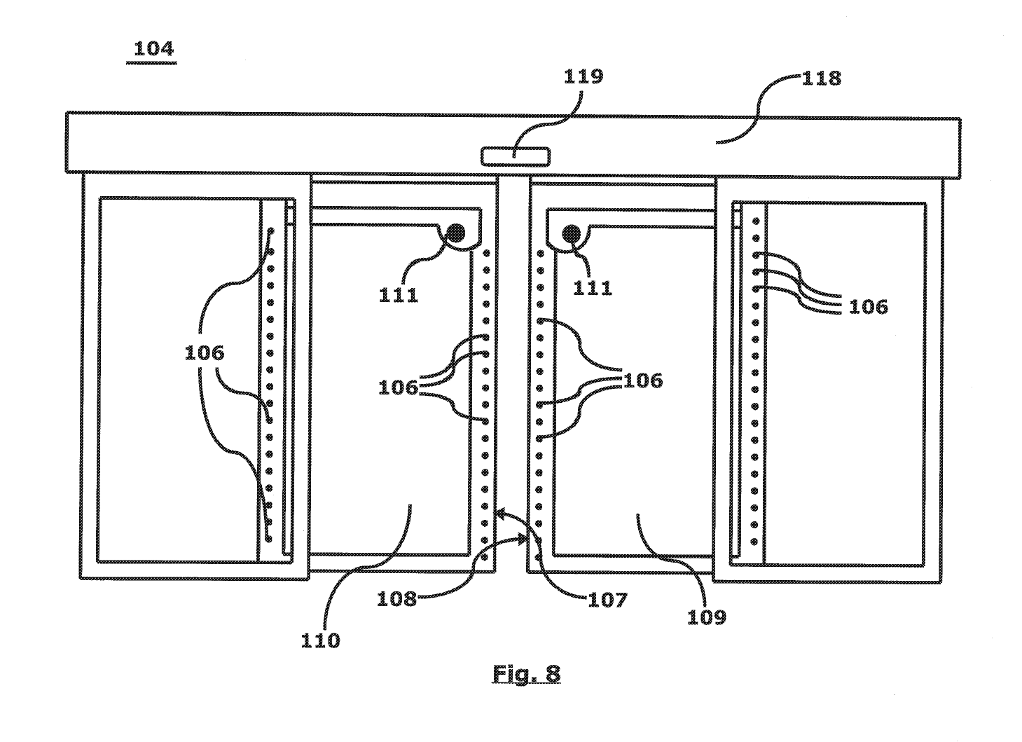

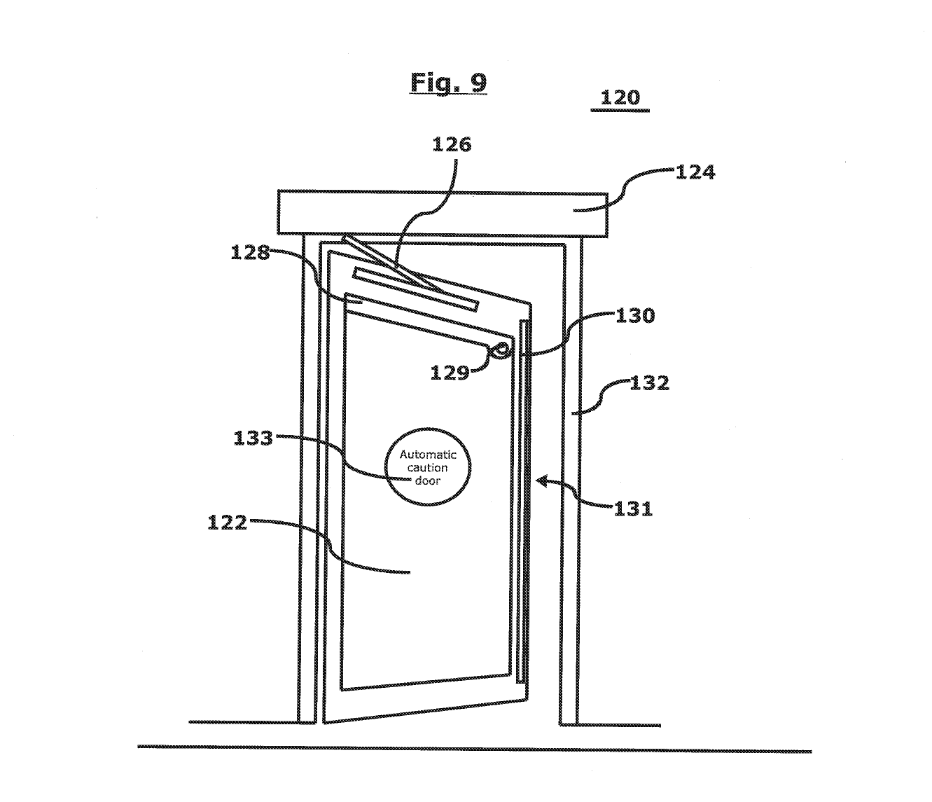

FIG. 8 is a front view of the exterior of the pair of sliding doors 109, 110 shown in FIG. 7. A presence and activation sensor 119 is connected to the actuator 118 for opening and preventing the sliding doors from closing on people when they are adjacent to the sliding doors 109, 110. Similarly, the engagement ends 107, 108 of the sliding doors, 109, 110 are shown.

In accordance with the present invention, the engagement ends 107, 108 also function as peripheral edges for the opposing door. For example, engagement end 107 functions as a peripheral edge for opposing sliding door 109, and engagement end 108 functions as a peripheral edge for opposing sliding door 110.

FIG. 9 is a front view of the interior side of a low energy automated door system 120 configured in accordance with the present invention. The automated low energy door 122 is powered by an actuator 124 utilizing an actuator bar 126. The door 122 includes an audio warning device 129 and a visual warning indicator 130, which is an array of lights.

In accordance with the present invention, the array of lights 130 is located on engagement end 131 of the door 122 which comes in contact with a peripheral edge 132, the door frame and wall, when the door 122 is in the closed position. The door 122 includes an “Automatic Caution Door” sign 133, or could include any additional required sign.

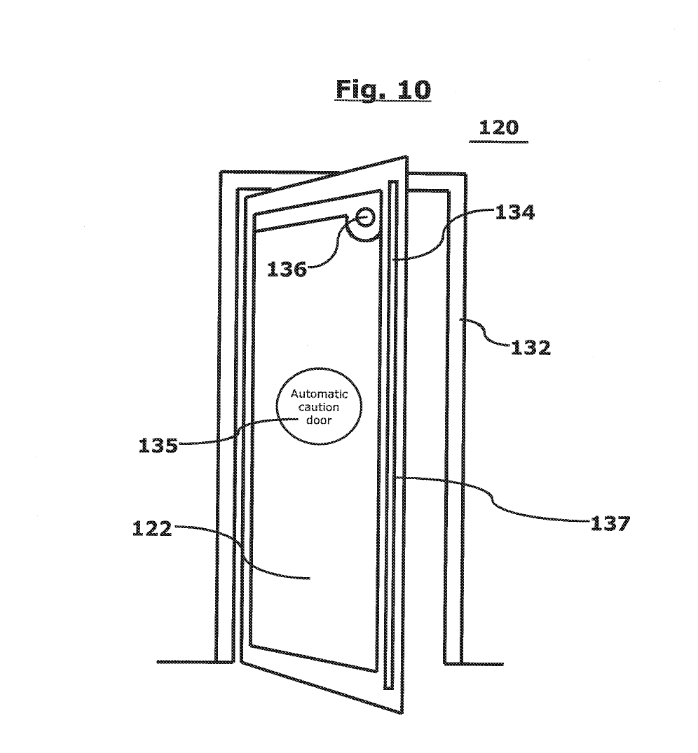

FIG. 10 is a front view of the exterior side of the low energy automated door 122 of the low energy automated door system 120 shown in FIG. 9. FIG. 10 shows a second array of lights 134 on the engagement end 137 of the door 122 which comes in contact with the peripheral edge or wall 132 when the door 122 is in the closed position. A second audio warning device or speaker 136 is attached to the exterior side of the door 122. An Automatic Caution Door warning sign 135 is located on the exterior side of the door 122.

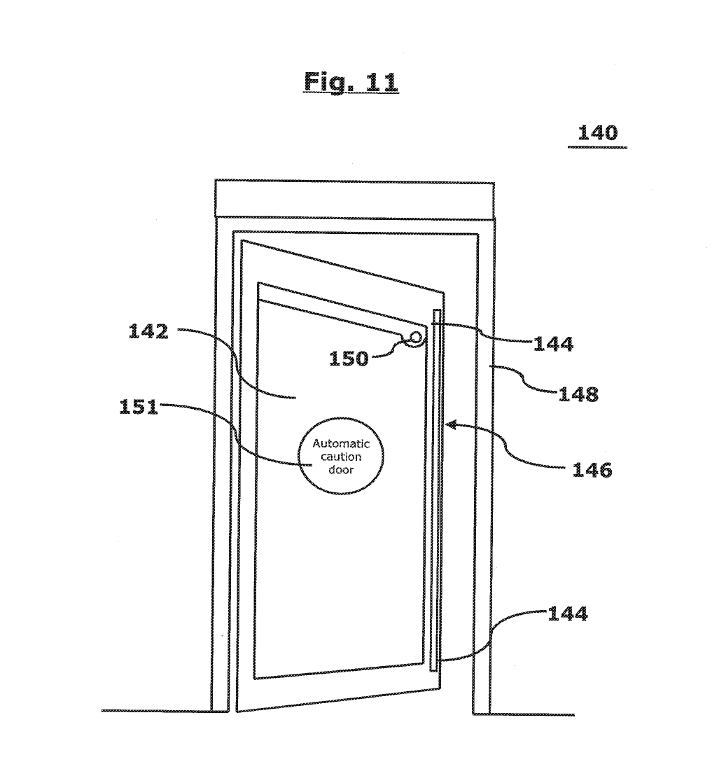

FIG. 11 is a front view of the interior side of a high energy automated door system 140 configured in accordance with the present invention. A high energy automated door 142 includes an array of lights 144 on the engagement end 146 of the door 142 which comes in contact with the wall 148 when the door 142 is in the closed position. A speaker 150 is included on the door 142 and an Automatic Caution Door warning sign 151.

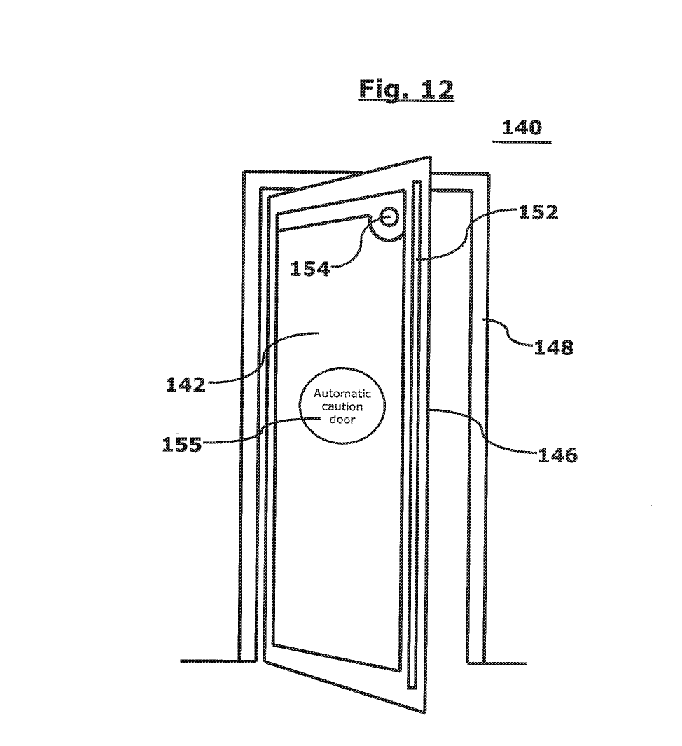

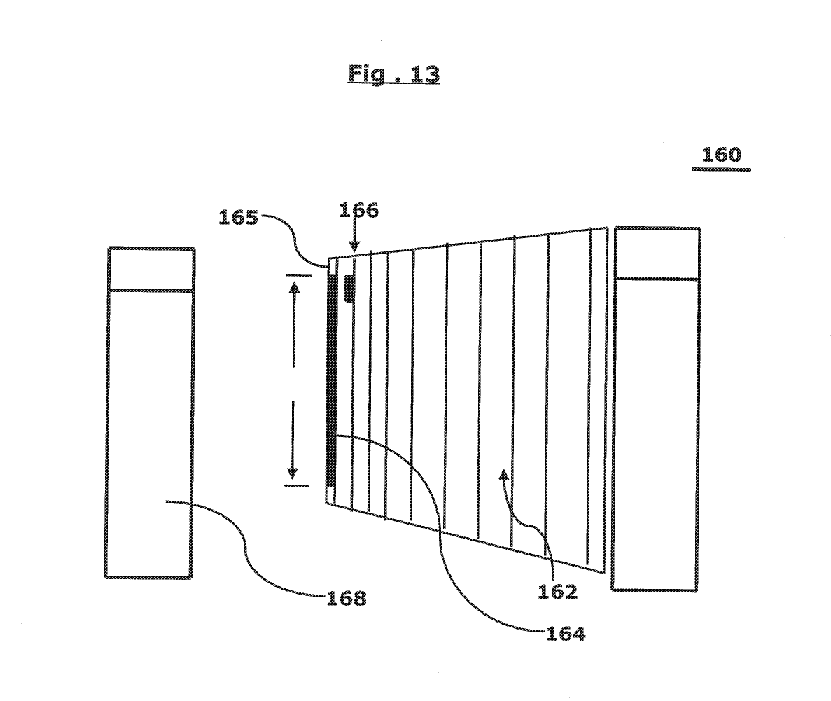

FIG. 12 is a front view of the exterior side of the high energy automated door 142 of the high energy automated door system shown in FIG. 11. The door 142 includes an engagement end 146 having an array of lights 152 on the exterior side, wherein the engagement end 146 comes in contact with the door frame or wall 148 is the closed position. A speaker 154 is included on the exterior side of the door 142. An “Automatic Caution Door” sign 155 also is located on the exterior side of the door 142.

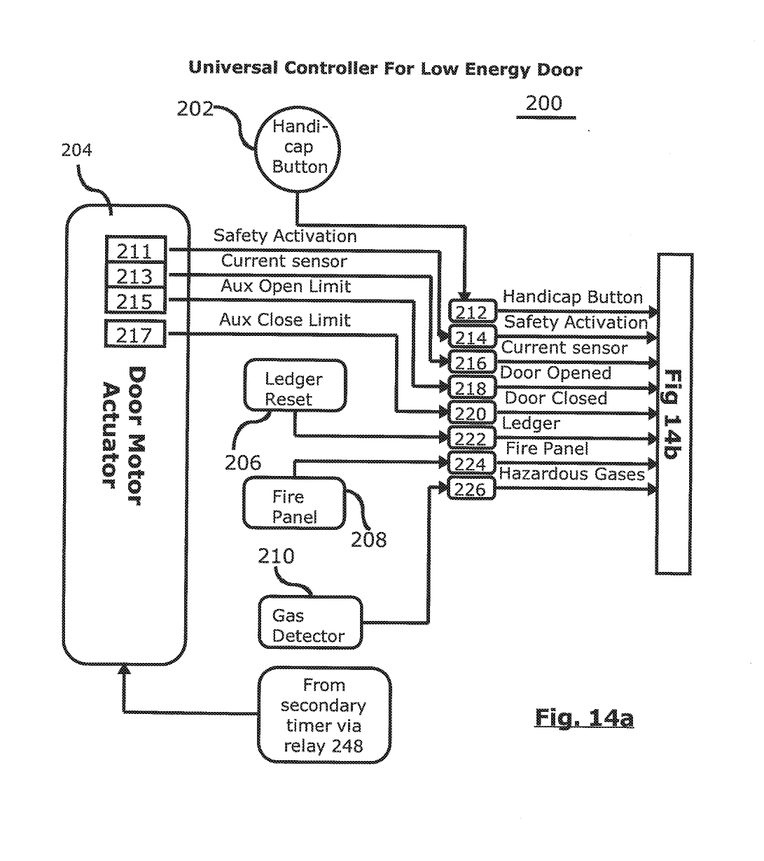

FIG. 13 is a perspective view of an automated gate 162 configured in accordance with the present invention. The automated gate system 160 includes a gate 162 having an array of lights 164 on an engagement end 165 which comes in contact with a fence 168 functioning as a peripheral edge. A speaker 166 is included on the gate 162 for announcing when the gate 162 is opening or closing, or about to open or close, and the array of lights 164 visually signal when the gate 162 is opening or closing, or about to open or close.

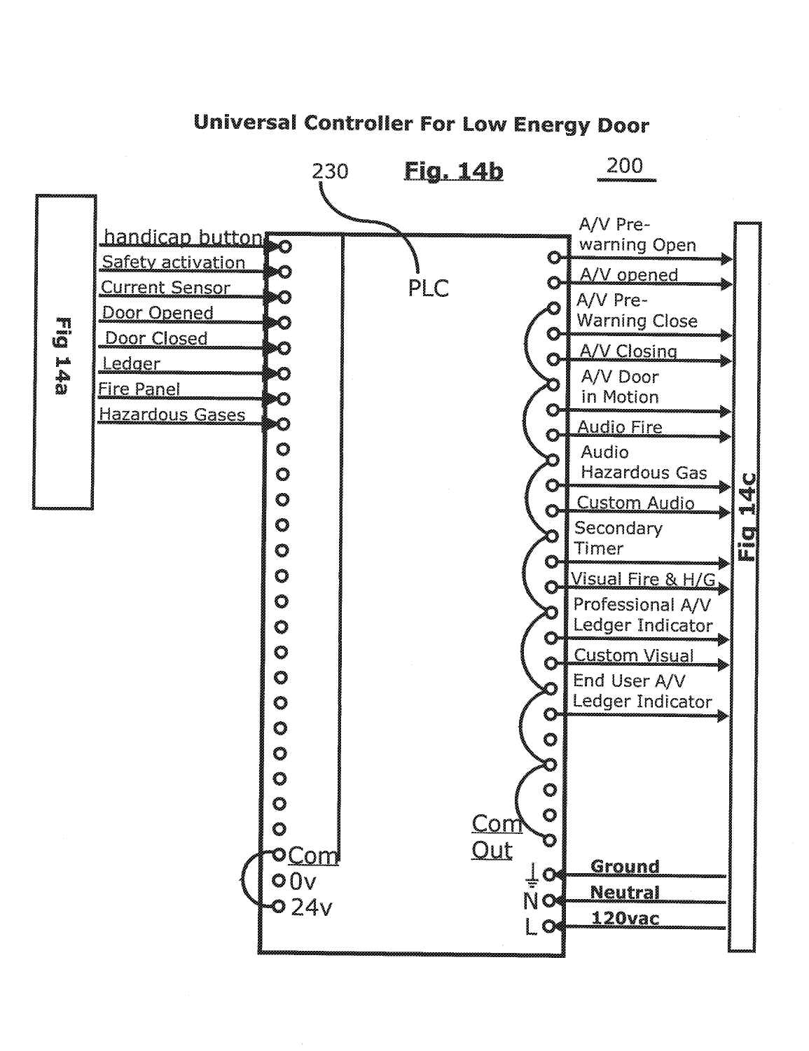

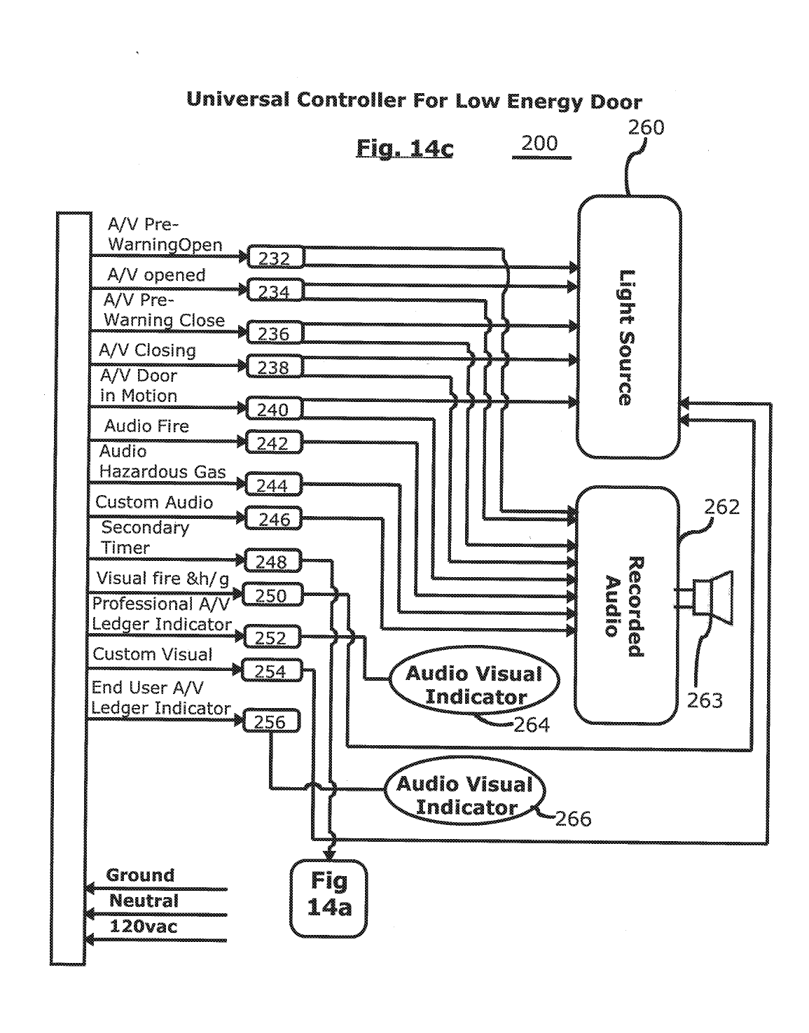

FIGS. 14a-14c illustrate a schematic of a universal controller 200 for low energy doors configured in accordance with the present invention. Shown in FIG. 14a are an activation input 202, a low energy door motor or actuator 204, a ledger reset input 206, a fire panel sensor and input panel 208, and a hazardous gas detector 210. The activation input 202 preferably is a handicap door open button, such as a MS Sedco 59J-HSS sold by MS Sedco from Indianapolis, Ind. The low energy door motor 204 can be a motion access low energy motor operator, such as sold by Motion Access from Elk Grove Village, Ill. The fire panel 208 is typically a part of the building fire system (Fire Panel contacts), and the hazardous gas detector 210 is typically a CO2 or multi-gas detector, such as a system sensor B200S.

Also illustrated in FIG. 14a are single-poll double-throw (SPDT) relays 212, 214, 216, 218, 220, 222, 224, and 226. The SPDT relays utilized in the present invention are commercially available, such as Cabur SPDT relay 12 v ac/dc CWRE7-0848, Phoenix SPDT relay 24 v ac/dc PLC-RSC-24UC/21, Phoenix DPDT relay 24 v ac/dc PLC-RSC-24UC/21-21AU or Phoenix SPDT relay 12 vdc PLC-RSC-12DC/21. The SPDT relays 212, 214, 216, 218, 220, 222, 224, 226 are electrically connected to the inputs of the PLC 230 shown in FIG. 14b. SPDT relay 212 is connected to the handicap button 202, SPDT relay 214 is connected to safety activation 211, SPDT relay 216 is connected to current sensor 213, SPDT relay 218 is connected to auxiliary open limit 215, SPDT relay 220 is connected to auxiliary close limit 217, SPDT relay 222 is connected to ledger reset 206, SPDT relay 224 is connected to fire panel 208, and SPDT 226 is connected to hazardous gas detector 210. The PLC is show in FIG. 14b is preferably a commercially available Schneider PLC with 24 inputs and 16 outputs which includes built in memory and a real time clock and calendar, and is part #TWDLCAA40DRF.

Low energy or handicap doors are usually activated by pressing a handicap button either inside or outside of the door requesting access. Anytime the handicap button is pushed or the current sensor 213 is activated, the PLC will maintain an open signal to the door motor actuator 204 until the door is completely open and held open for at least 5.5 seconds. The following is the operating function of the illustrated circuitry 200 for the low energy door system 120 shown in FIGS. 9 and 10.

Process Before the Door Opens:

The handicap button 202 is depressed to send an access signal to SPDT relay 212 to the PLC 230. The auxiliary close limit 217 detects whether the door is closed by monitoring the close limit, detects weather the door is closed. The handicap button 202 and the auxiliary limit close 217 in the door motor operator/actuator 204 both must be active to create a closed circuit, wherein the PLC 230 will send a signal A/V Pre-Warning signal via relay 232 to energize the light source 260 and the recorded audio 262 to be output via speaker 263. For example, the light source 260 will flash red and the recorded audio will state, “Stand clear, door will be opening.”

Door Opening:

After a predetermined time has expired, such as three seconds, the PLC 230 energizes the Secondary Timer via relay 248 to the door motor actuator 204 to begin opening the door. While the door is opening, Current Sensor 213 on the door motor 204 is energized. The PLC 230 responds by energizing A/V Door in Motion output 240 which activates the visual light indicator 260 which is solid red and the audio warning device 262 and then 263 which states, for example, “Stand clear, door in motion,” The PLC 230 keeps Secondary Timer output via relay 248 energized to open the door.

Door Opened:

Once the door has reached full open, Current Sensor 213 will deactivate and Aux Open Limit 215 will be activated while door is opened. A/V Opened output via relay 234 then energizes visual warning indictor 260 to turn lights green, and the audio device 262 and then 263 to state, “Automatic Caution Door” or verbally states required sign, Secondary Timer 248 keep door open for at least 5.5 more seconds.

Pre Warning Close:

With at least 2.5 seconds remaining on the Secondary Timer via relay 248, the PLC 230 energizes A/V Closing output via relay 236, which energizes the visual warning indicator 260 to flash red, and the audio warning device 262 then 263 to state, “Warning, door will be closing.”.

Closing:

The PLC 230 deactivates Secondary Timer output via relay 248, allowing door to close, and thus de-energizing aux open limit 215 to de-energize relay 218. The PLC detect de-energized aux open limit 215 de-energizing 218 and no input from current sensor 213, and de-energize 216 energizing A/V Closing output via relay 238 to the visual warning indicator 260 to solid red, and the audio warning device 262 then 263 to state, “Stand clear, door closing.”

Closed:

After the door is completely closed, then Auxiliary Close Limit sensor 217 will energize input via relay 220 to PLC 230. In response, the PLC 230 energizes Custom Audio output via relay 246 to state, a custom audio “thank you for shopping at whatever store,” and Custom Visual Output via relay 254 to custom visual or image can be located on the door.

Fire:

Fire panel 208 is wired from a set of dry contacts which energize relay 224 input to PLC 230 energizing output relay 242 connected to 262 and then 263 for audio, also relay 250 connected to 260 for visual, preferably white.

Hazardous Gas Detector:

Hazardous gas detector 210 is wired from a set of dry contacts which energize relay 226 input and is connected to PLC 230 which energizes output relay 244 and energizes 262 the 263 for audio, also relay 250 which energizes 260 for visual, preferably a white light.

Daily or Scheduled Safety Check or Test Ledger System:

Once the daily or scheduled safety check or test has expired PLC 230 output relay 256 A/V indicator will activate the audio/visual indicator 266. Ledger reset 206 connected to relay 222 will activated and reset daily or scheduled safety check or test. Also data can be stored remotely as well as locally.

Professional Inspection Ledger System:

Once the professional annual or scheduled inspection timer has expired. The PLC 230 output relay 252 will active an audio/visual indicator 264. Ledger input from the data port located with in the PLC using an HMI will activate and reset annual or scheduled professional inspection timer in the PLC 230 and can store data in server 61 both remotely and locally.

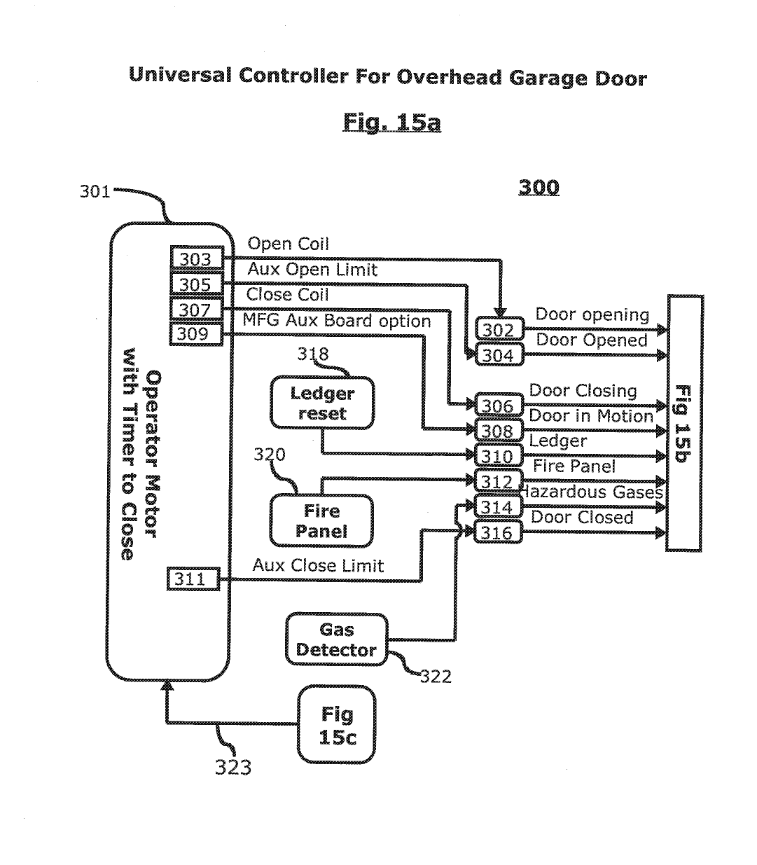

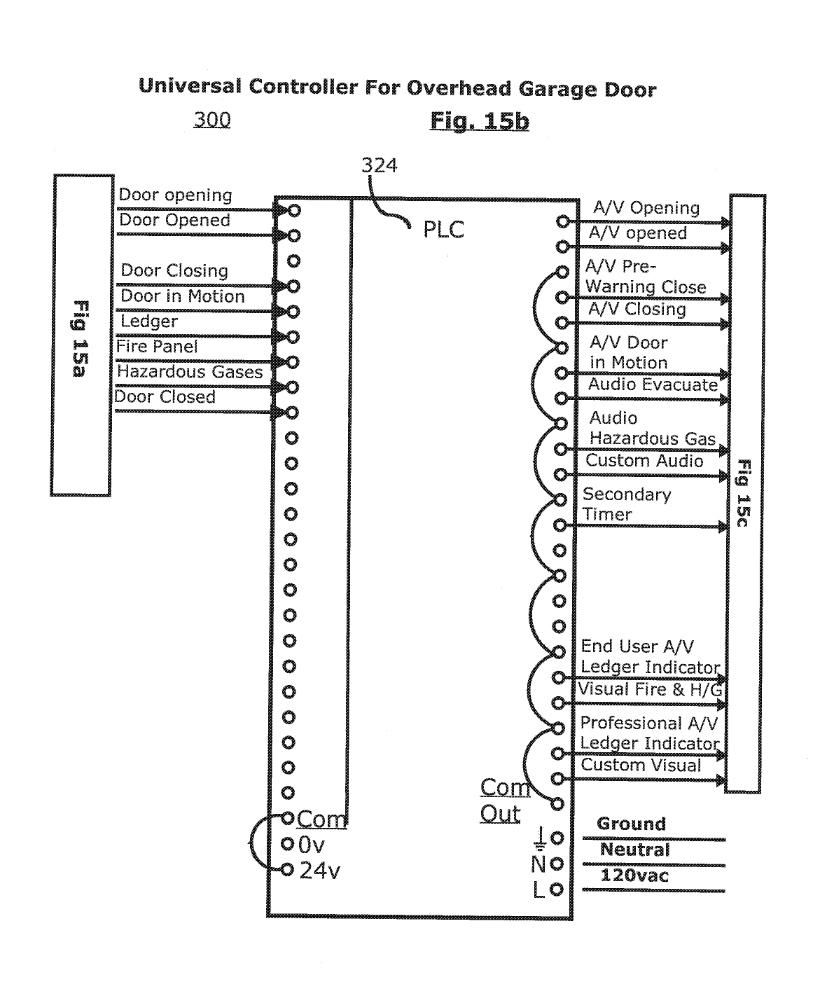

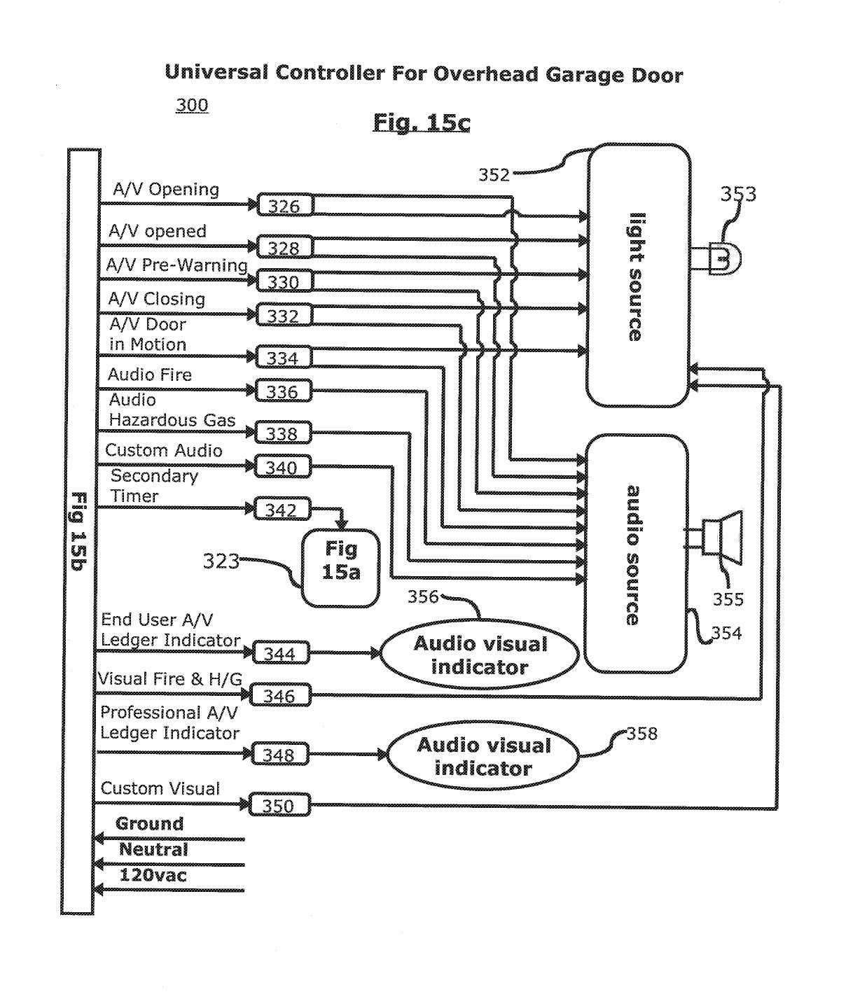

FIGS. 15a-c illustrate a schematic of a universal controller 300 for an overhead garage door configured in accordance with the present invention. The following is the operating function of the illustrated circuitry 300 for the overhead garage door system 10 shown in FIGS. 1 and 2.

Opening:

Actuator/operator motor 301 receives a signal to open via a push button or a radio control transmitter, which causes open coil 303 to be energized. Relay 302 connected to the door opening input of PLC 324 is activated, which activates the door and the Aux Close Limit 311 is deactivates, and then relay 316 connected to door closed becomes deactivated. The PLC 324 energizes DPDT relay 326 connected to A/V Opening output 352 and 353 for solid red light and 354 then 355 audio which can state, “Caution door is opening Beep Beep Beep.”

Opened:

Relay 302 is connected to Open Coil 303 of Operator Motor 301 is deactivated and Aux Open Limit 305 activates relay 304 which is connected to Door Opened input of PLC 324. PLC 324 then energizes relay 342 connected to Secondary Output of PLC 324, while PLC timer is timing out and DPDT relay 328 connected to PLC output A/V opened energizing relay 326 which energizes 352 and 353 for solid green and 354 audio source to 355 to states “Proceed with caution”.

Pre Warning to Close:

Manufacturer's timer has expired sending signal to close Open Coil 303 which is interrupted by the Secondary Timer output of PLC 324 connected to relay 342 which continues to interrupt close circuit 323 to Operator Motor 301. Aux Open Limit 305 remains active to relay 304 which is connected to Door Opened input of PLC 324. Relay 342 connected to Secondary Timer output of PLC 324 remains activated, and DPDT relay 330 connected to A/V Pre-Warning output 352 and 253 to flashing red lights and 354 audio to 355 which states, “Stand clear door will be closing”.

Closing:

Secondary Timer output of PLC 324 connected to relay 342 is deactivated, allowing door to close. Close Coil 307 in operator motor 301 energizes relay 306 connected to Door Closing input of PLC 324. PLC 324 then energizes A/V Closing out connected to relay 332 which activates light source 352 and 253 for solid red lights and audio source 354 to 355 which states, “Stand clear door closing”.

Closed:

Aux close limit 305 to Door Closed input PLC 324 via relay 316 activates Custom Audio output of PLC 324 to both audio relay 340 to audio source 354 then 355 for a custom audio statement and visual relay 350 to light source 352 and 353 are activated giving a custom visual.

Fire:

Fire panel 320 is wired from a set of dry contacts which energize relay 312. PLC 324 energizes SPDT relay 336 connected to audio fire output to audio source 354 and 355 also relay 346 connected from output of PLC 324 Visual Fire & H/G to a white light source 352 and 353 for fire. PLC 324 energizes relay 351 to 360 open input of motor operator for the door.

Hazardous Gas Detector:

Hazardous gas detector 322 is wired from a set of dry contacts which energize relay 314 and is connected to PLC 324 hazardous gas input, causing PLC 324 to energize output audio hazardous gas to audio source 354 via SPDT relay 338, and also energize light source 352 from PLC 324 output visual fire and H/G via relay 346. PLC 324 energizes relay 351 to 360 open input of motor operator for the door.

Daily or Scheduled Safety Check or Test Ledger System:

Once those responsible for the equipment, daily or scheduled safety check or test timer has expired, PLC 324 output A/V indicator will activate audio visual indicator 358 via relay 348. Ledger reset 318 will be activated and reset daily safety check or test timer. PLC 324 can store time and date stamp data of checks and tests. Data can be stored remotely or locally on server 61.

Professional Ledger System:

Once those responsible for the equipment, annual or scheduled professional inspection timer has expired, professional inspection A/V indicator will activate audio visual indicator 358 via relay 348. Ledger input from the data port located within the PLC using an HMI will activate and reset annual timer in PLC 324 and can store time and date stamp data of inspections. Data can be stored remotely or locally on server 61.

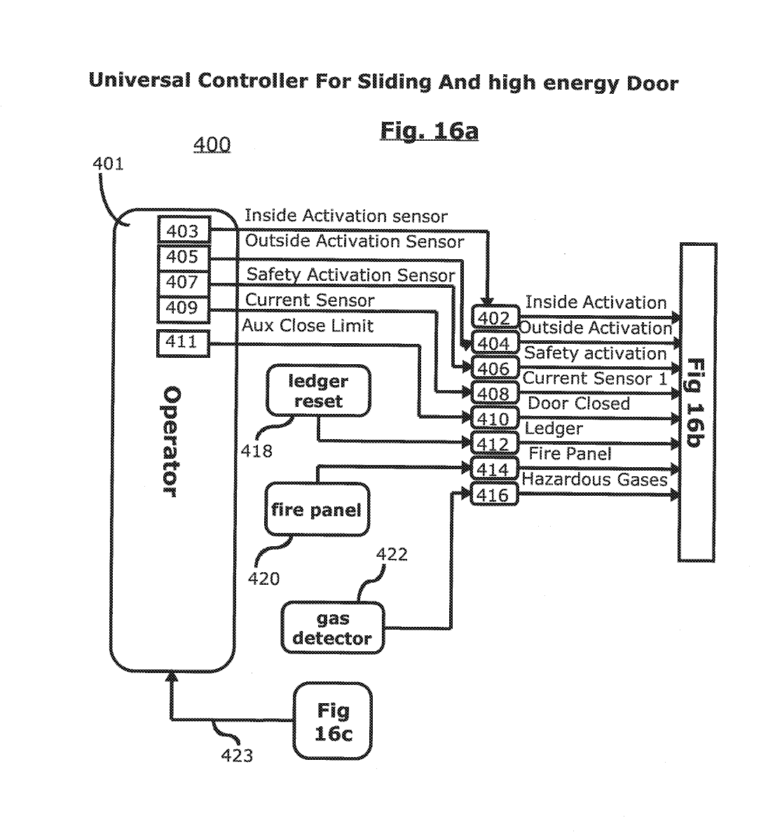

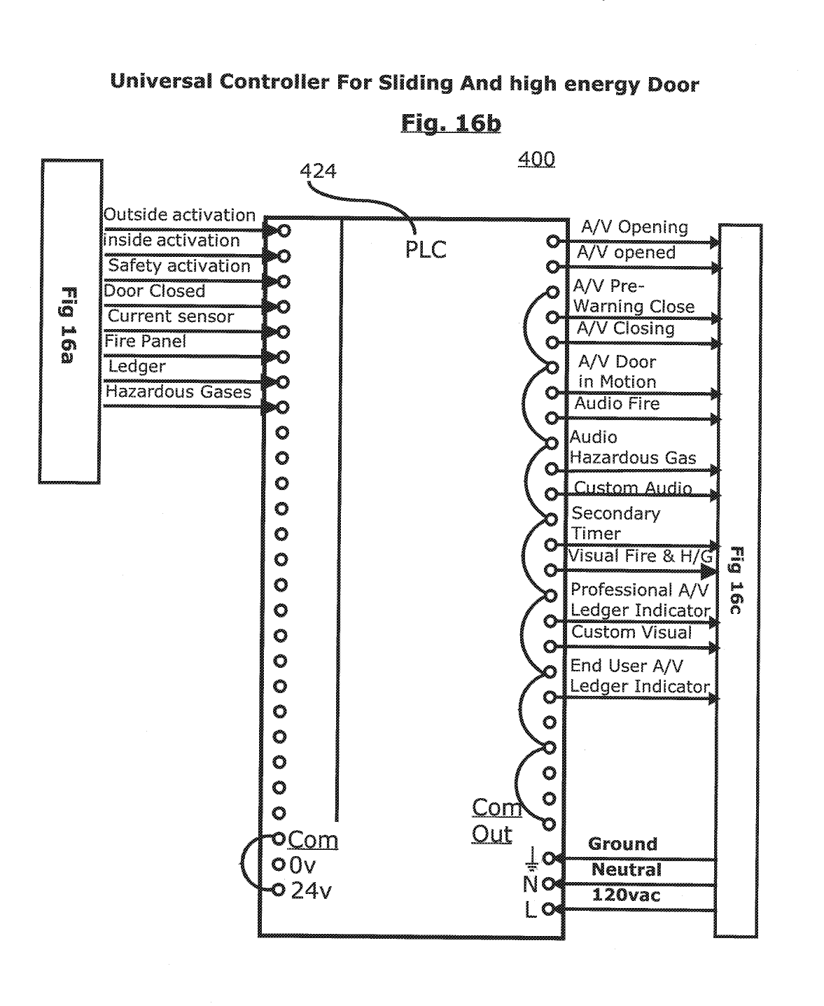

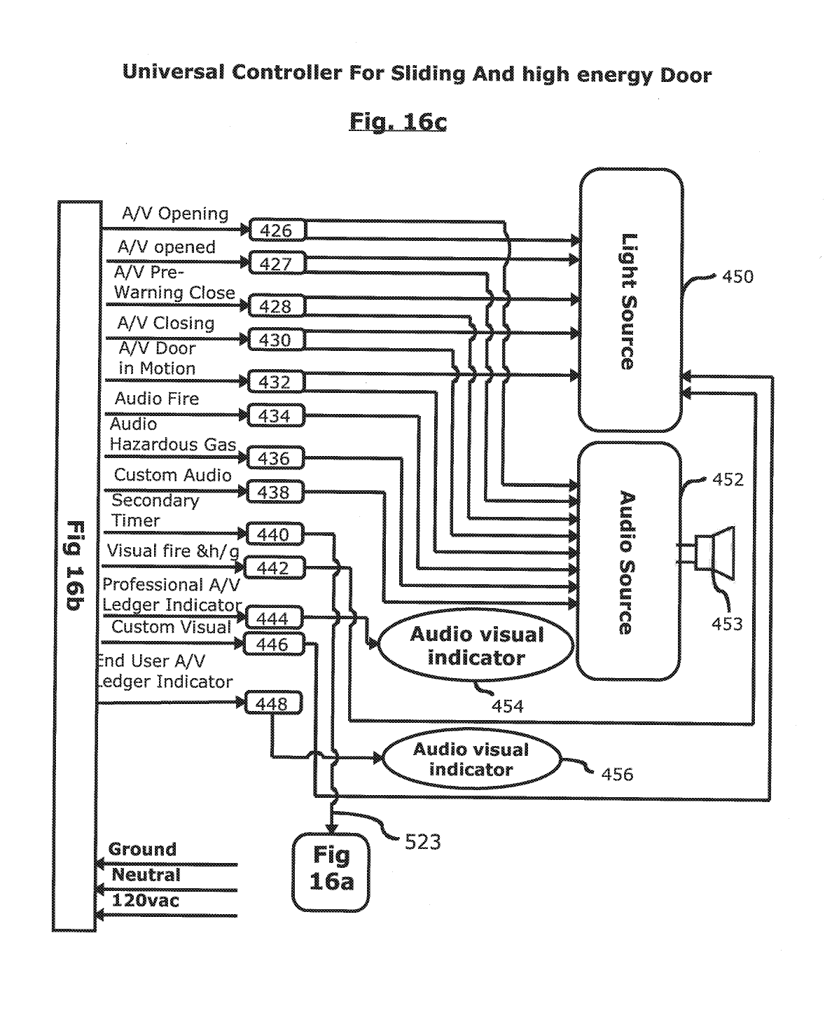

FIGS. 16a-c illustrate a schematic of a universal controller 400 for a sliding and high energy door configured in accordance with the present invention. The following is the operating function of the illustrated circuitry 400 for the sliding door system 104 shown in FIGS. 7 and 8.

A person walks up to door and an activation sensor inside or outside sensor 403 or 405 becomes energized activating relays 402 or 404 sensors energizes the door motor or operator 401. Door begins to move activating current sensor 409 and current sensor relay 408, and the inside or outside activation relays 402 and 404 are activated and de-energizes 411 aux close limit relay 410. PLC 424 energizes secondary timer and relay 440 which goes back to the operator 401 and wires to the safety input of the operator, also energizes the relay 426 for A/V opening. Which activates light source 450 solid red and audio source 452 which goes to 453 which states: “Stand clear door opening

Door Opened:

Activation sensor 403 or 405 energize relay 402 or 404 is still energized by people in the path of sensor inside or outside relays 402 or 404 are activated and current sensor 409 deactivates relay 408 is de-activated and aux close limit 411 and relay 410 is de-energized. PLC 424 energizes secondary timer relay 440 remains energized and relay 427 for A/V open is energized. Which activates light source 450 solid green and audio source 452 which goes to 453 which states: “Caution automatic door keep moving” or states what required signage would say.

Pre-Warning Close:

All activation sensors 403 and 405 are de-activated because nothing in path of sensors inside and outside relays 402 and 404 are de-energized. PLC 424 continues to hold door open with secondary timer relay 440 for predetermined time allotted and further energize relay 428 for activation of A/V pre-warning close. Which activates light source 450 flashing red light and audio source 452 which goes to 453 which states: “Stand clear door will be closing”

Door Closing:

Secondary timer has timeout and de-energize relay 440 so door can start to close. Also the inside and outside sensors 403 and 405 and relays 402 and 404 have to remain de-energized and the current sensor 409 and relay 408 becomes energized while motor 401 is in motion. PLC 424 energizes relay 430 for A/V closing. Which activates light source 450 solid red and audio source which goes to 453 which states: “Stand clear door closing”

Door Closed:

Aux close limit 411 energizes relay 410 and all other inputs are de-energized. PLC 424 energizes for predetermined time. Custom visual relay 446 and custom audio relay 438 are both energized permanently or for a predetermined allotted time.

Fire:

Fire panel is wired from a set of dry contacts from the fire panel 420 which will energize relay 414. PLC 424 energizes SPDT relays 442 and 434 for an A/V for fire. PLC 424 energizes relay 449 and go to 458 back to the activation of the motor operator for the door.

Hazardous Gas Detector:

Hazardous gas detector is wired from a set of dry contacts from the hazardous gas detector 422 which will energize relay 416, and PLC 424 energizes SPDT relays 442 and 436 for an A/V for hazardous gas detection. PLC 424 energizes relay 449 and go to 458 back to the activation of the motor operator for the door.

Daily or Scheduled Safety Check or Test Ledger System:

Once those responsible for the equipment referred to as end users daily or scheduled safety check or test timer has expired, relay 448 is activated and A/V indicator 456 will be activated. Ledger input 418 will activate relay 412 and reset daily safety check or test timer in PLC 324, and PLC 424 can store time and date stamp data of checks and tests data both remotely and locally.

Professional Inspection Ledger System:

Once the professional annual or scheduled inspection timer has expired, relay 444 activates 454 A/V indicator is energized. Ledger input from the data port located within the PLC 424 using an HMI will be activate and reset annual timer in PLC 424, and PLC 424 can store time and date stamp data of inspections both remotely and locally.

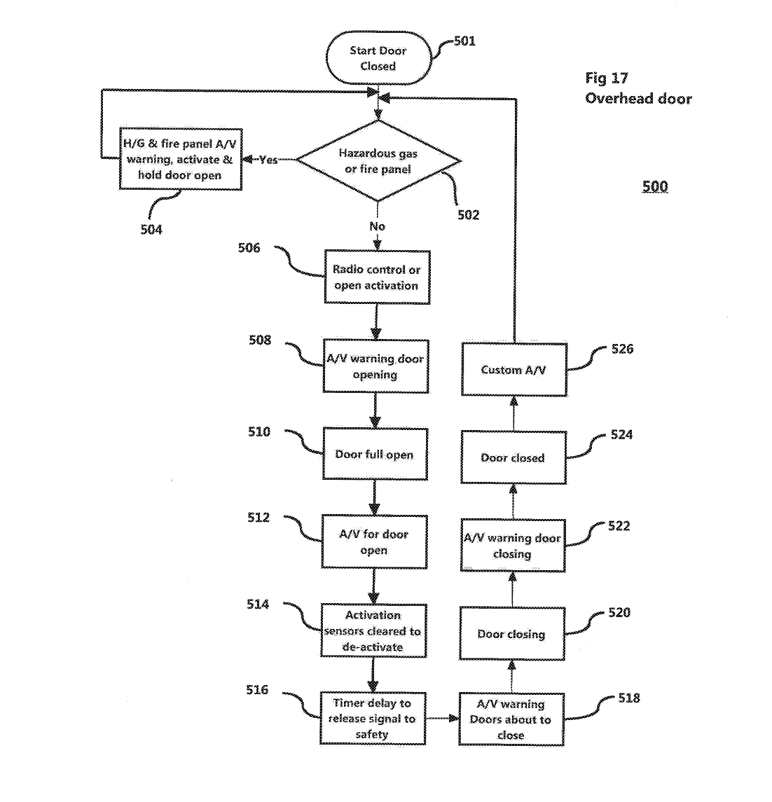

FIG. 17 illustrates the preferred operating process or method for an overhead garage door in accordance with the present invention, such as illustrated in FIGS. 1 and 2. Beginning at the start at step 501, the process moves to step 502 to determine whether it the hazardous gas or fire panel has detected a problem or emergency situation. If yes, the method moves to step 504 wherein the hazardous gas and fire panel activates the audio and visual warning systems activates and holds the overhead garage door open until the emergency situation is terminated.

If no emergency situation exists in step 502, the method moves to step 506 where the system waits for an open signal from a pushbutton or a radio transmitter. Upon receiving an open command signal, the method moves to step 508 wherein the audio and visual devices indicate the door is opening. Here, the audio could state “Warning, the door is opening,” and the visual warning indicator flash red. Next, the system moves to step 510 wherein the door is fully open. Once the door is fully open, the method in step 512 activates the visual indicator to be a green light and the audio device to state, “The door is open proceed with caution.”

Next in step 514, the method checks the activation sensors to confirm no object is standing in the way of the garage door to close. If there is nothing obstructing the door from closing, the method next moves to step 516 wherein a timer waits a predetermined period of time before allowing the door to close. After the time delay has passed, the method moves to step 518 wherein the audio warning apparatus states, “Warning, door is about to close” and the visual warning indicator flashes red. Then in step 520 the door begins to close and in the following step 522 the body of warning apparatus states, “Warning, the door is closing,” and the visual warning indicator flashes red. Following in step 524, the door is closed and then in step 526 a customized audio statement is made by the audio warning apparatus and a customized visual signal is energized.

After step 526, the method returns to step 502 wherein the method checks again for an emergency situation, and if none exists, the method moves once again to step 506 and awaits an open activation command.

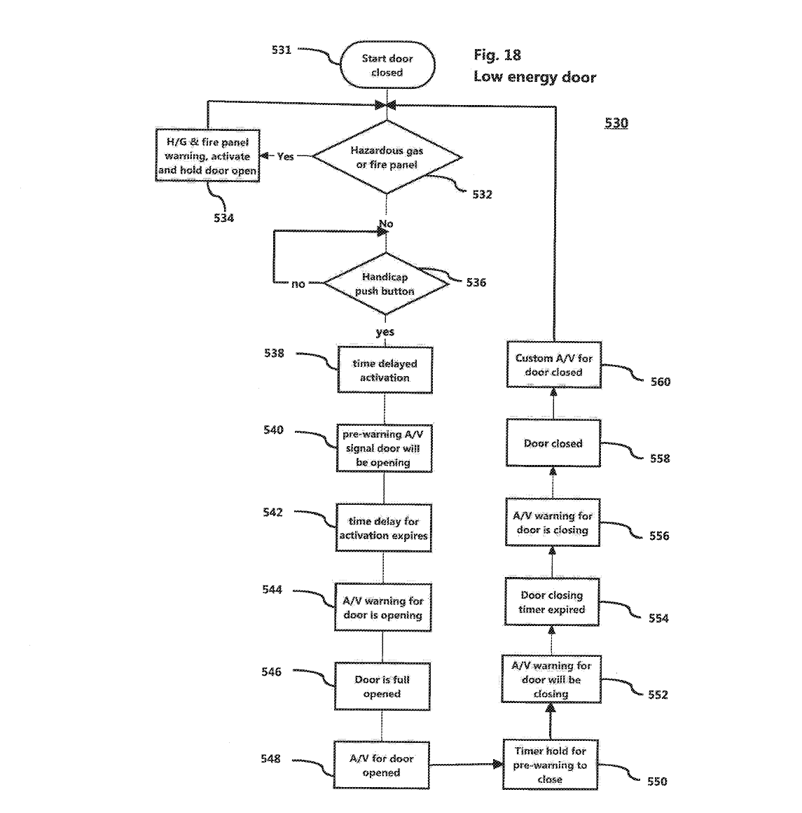

FIG. 18 illustrates the preferred operating process or method for low energy door in accordance with the present invention, such as illustrated in FIGS. 9 and 10. Beginning at step 531, the door is in the closed position. The method then moves to step 532 wherein the system checks for hazardous gas, fire, or other emergency condition. If an emergency situation exists, the method moves next to step 534 wherein the hazardous gas and fire panel warning are activated and the system activates the door and holds the door open. If no hazardous or emergency situation exists or ends, the method moves next to step 536 wherein it awaits the input from an open command, such as from a handicap pushbutton. Once a push button is activated, in step 538 there is a delay on open. During delay the method goes to next step 540 wherein the audio warning device and visual warning indicator signal that the door will be opening. For example, the visual warning indicator flashes red, and the audio warning apparatus states, “Warning, the door will be opening.” After a predetermined time delay in step 542, the audio warning apparatus, which is preferably attached to the door, states, in step 544 “Warning, the door is opening.” The visual warning indicator is preferably an array of lights located on an engagement end of the door that comes in contact with a peripheral edge, such as the door frame.

In the next step 546 the door has moved to the fully open position, and in step 548 the audio warning apparatus states, “The door is open,” “Automatic caution door,” “Door can close without warning,” or state any required signage and the visual warning indicator emits a green color. In the next step by 550 the doors pre-warning to close, wherein a timer holds the door open for a predetermined period of time before the door begins to close. While door is timing out it goes into the next step 552 and the audio warning apparatus states, “Warning, the door is about to close,” and the visual warning indicator flashes red. Then in step 554 the hold open timer expires and the door begins to close. In step 556 the audio and warning apparatus states, “Warning, the door is closing,” and the visual warning indicator flashes red. In step 558 the door becomes fully closed, and in step 560 the audio warning apparatus states a customized message and energizes signal to custom visual.

After the final step 560 wherein the customized message is stated and visual signal is emitted, the method returns to step 532 wherein system checks for a hazardous condition. If no hazardous condition exists, the method moves to step 536 wherein it awaits an open signal command, such as from a depressed handicap button.

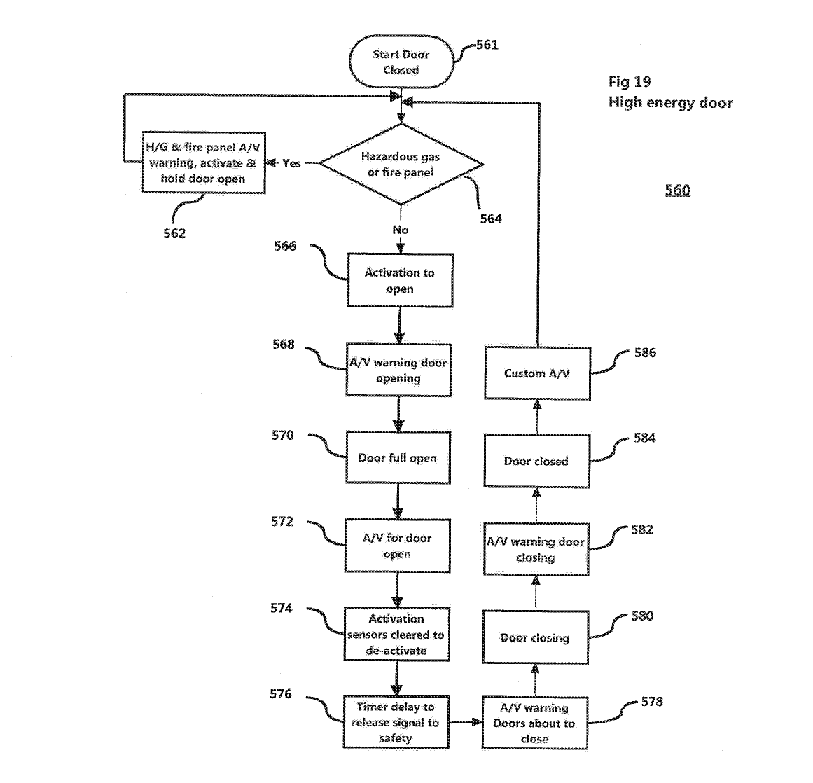

FIG. 19 illustrates the preferred operating process or method for a high energy door in configured in accordance with the present invention, such as illustrated in FIGS. 11 and 12. The method begins at step 561 and then moves to step 564 where it checks for hazardous gas or emergency condition. If an emergency condition exists, the process moves to step 562 wherein the method opens door and keeps it open until the emergency condition terminates. After the emergency condition is eliminated, the process returns to step 564 where it checks again for hazardous conditions.

If no emergency condition exists, the process moves to step 566 wherein the system waits for an activation to open signal, such as from a floor mat sensor, and then open is activated. Next in step 568 visual indicator turns red and audio and warning apparatus states “Stand clear door opening” Next in step 570 the door opens fully, and the audio warning apparatus states “Automatic caution door, keep moving” or required signage and the visual warning indicator flashes green in step 572.

In step 574 of the process checks to confirm that no one is standing on the floor mat sensor or standing within range of the activation sensor. Next in step 576 the timer hold door open to allow time for the warning to take place. Before the door begins to close, in step 578 the audio warning apparatus states, “Warning, door about to close” and the visual warning indicator flashes red.

In step 580 is door begins closing in the audio warning apparatus states. 582 “Warning, door is closing” and the visual warning indicator solid turns red. Following in step 584 the door becomes fully closed, and in step 586 the audio apparatus makes a customized statement and emits a customized visual on the surface of the door.

After step 586 process returns to step 564 to check for a hazardous or emergency condition, and if none exist, the process moves to step 566 again to await in activation signal to open the door.

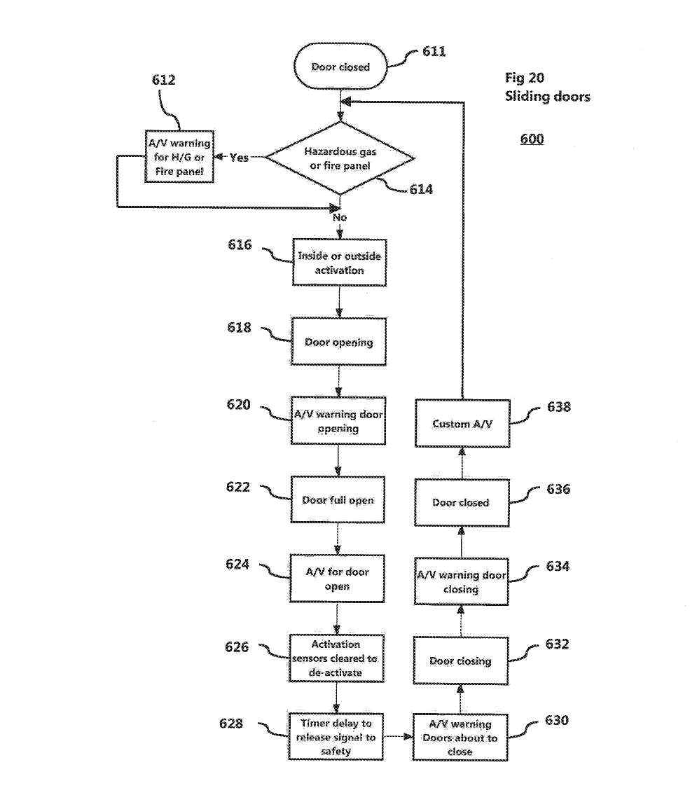

Turning now to FIG. 20 which illustrates the preferred operating process or method for a sliding door in configured in accordance with the present invention, such as illustrated in FIGS. 4 and 7. The method begins at step 611 with the door closed. The process then moves to step 614 wherein it checks to see if the hazardous gas sensor or fire panel has been activated. If yes, the method proceeds to step 612 wherein the process activates the audio and visual warning systems for the hazardous gas or fire alarm and opens door. After the emergency situation has terminated or if there was no prior emergency situation, the process moves to step 616 and awaits an activation signal from a motion sensor or a pressure detection sensor on the floor.

After receiving in activation signal in step 616, the process moves to step 618 wherein the door begins opening, and then while the door is opening, the system moves to step 620 wherein the audio warning device states, “Caution, door opening,” and the visual warning indicator flashes a solid red color. Once the door reaches the full open position in step 622, the process moves to step 624 wherein the audio warning apparatus states, “Automatic door keep moving” or required signage stated verbally and the visual warning indicator turns a solid green.

After the door has been fully opened, the process in step 626 awaits for the activation sensors to be clear and deactivate. Next in step 628 the timer delay holds the door to open for a predetermined period of time giving time for step 630. In step 630 the audio warning apparatus states. “Caution, the door is about to close,” and the visual warning indicator flashes red. Next in step 632 the door begins closing and in step 634 the audio warning apparatus states, “Caution, the door is closing,” and the visual warning indicator turns solid red.

After the door is fully closed in step 636, the process moves to step 638 wherein a customized audio statement is made and a customized visual signal is emitted. After the customized audio statement and visual signal are made, the process returns to step 614, check for a hazardous condition, and if none exists, the process moves to step 616 again to wait in activation signal.

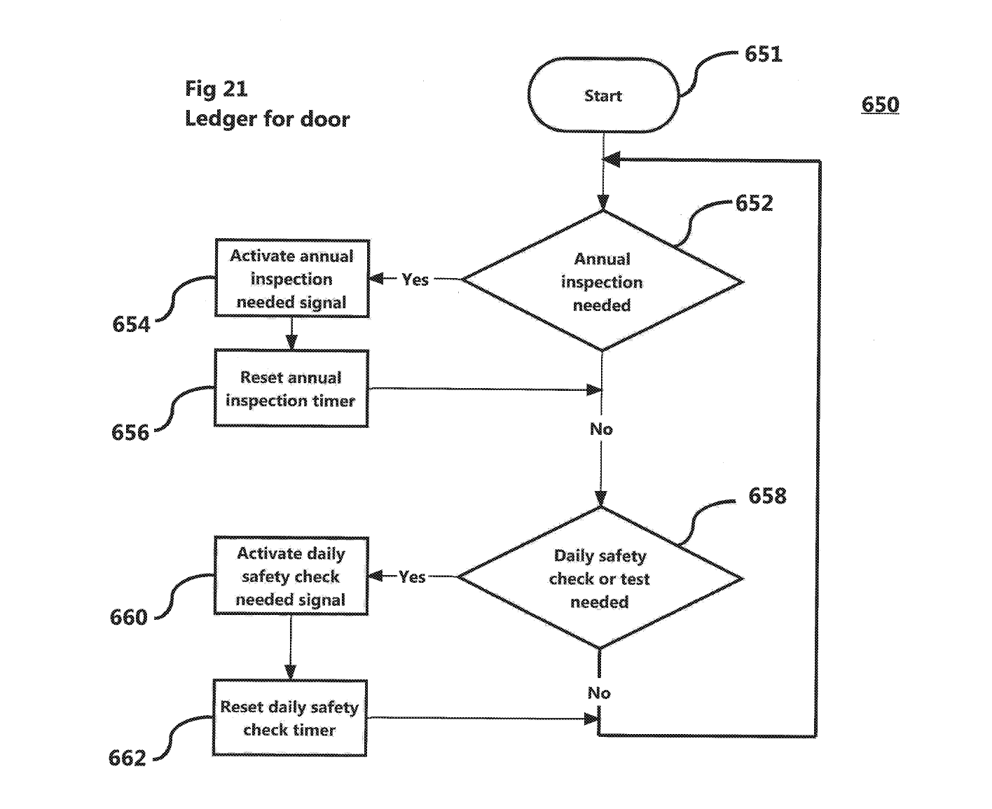

FIG. 21 illustrates a process of an A/V indicator needs to perform a safety check, test or inspection, recording and logging test status results in accordance with the present invention. The process preferably is executed at least once daily. Beginning with step 651, the process moves to step 652 to check if an annual inspection is needed. If an annual inspection is needed, the process proceeds to step 654 to activate the annual inspection needed signal, such as the audio and visual annual test signals 99 shown in FIG. 4. The A/V annual test inspection needed signal remains activated until an annual inspection has been performed upon the automated door by the appropriate inspection professional. After an annual inspection has been performed and the annual inspection timer is reset in step 656, the process moves to step 658 to check if a daily safety check or test is needed.

At step 658 the process checks to determine if a daily safety check or test in needed to be performed. If a daily safety check or test is due, the process moves to step 660 and activates the daily inspection needed signal, such as the audio and visual daily test signal 98 shown in FIG. 4. The A/V daily test inspection needed signal remains activated until a daily inspection has been performed on the door. After a daily safety check has been performed and the daily safety check timer is reset in step 662, the process returns to step 652 to repeat the process the next day.

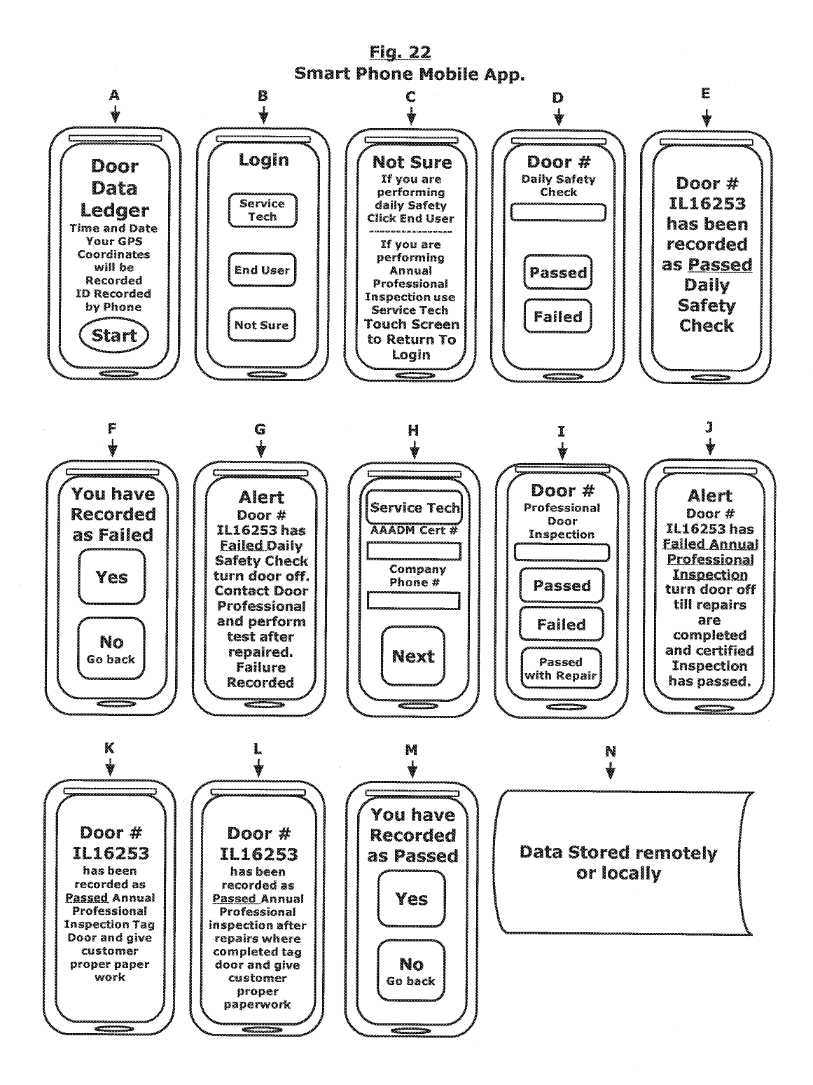

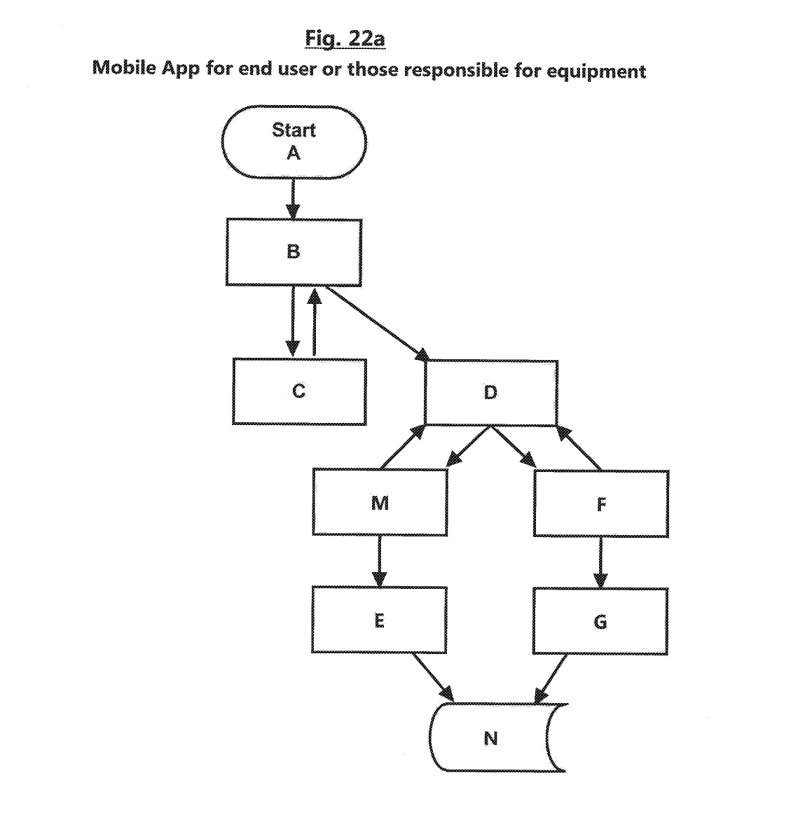

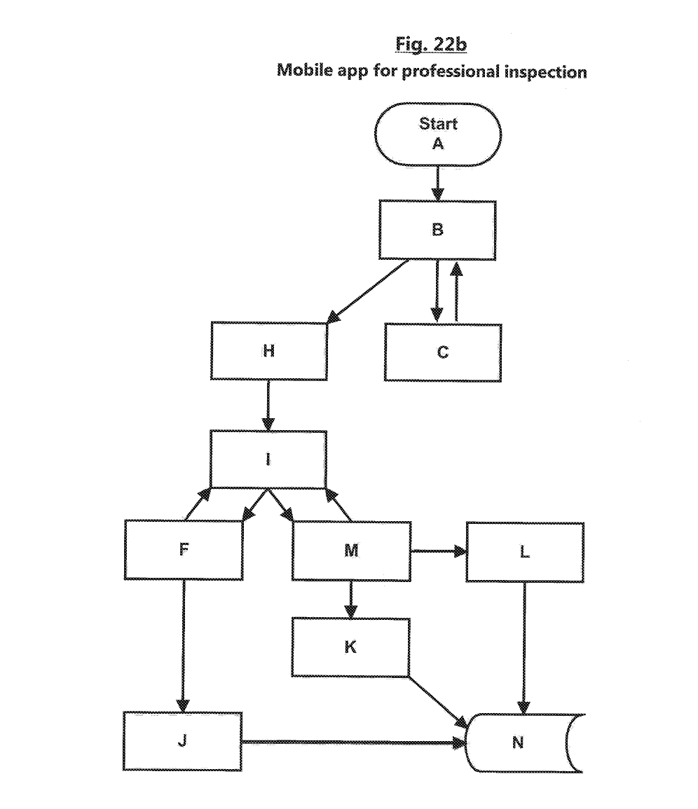

FIG. 22 illustrates examples labeled A-M of displays for a smartphone being used in daily and annual inspections of an automated door in accordance with a method of the present invention. Each of these displays will be described below in reference to FIGS. 22a and 22b. The smartphone, such as an IPhone made and sold by Apple®, can be used to implement the inspection method of the present invention.

Referring to FIG. 22a, illustrated is a flowchart of steps and displays of a software application for a mobile smartphone being used by an end user are required to perform the daily safety check or test method of the present invention. The illustrated flowchart of FIG. 22a is intended for end users or those responsible for maintaining the proper function of an automated door and related equipment.

Beginning at display and step A from FIG. 22a a daily safety check or test is performed by an end user, and then the end user touches the Start on the display to begin the program on the smartphone. Next in step and display B, the operator chooses Service Tech, End User or Not Sure. Entering “Not Sure” moves to step and display C which describes the difference between Service Tech and End user, and touching the display screen of the smartphone brings the operator back to step and display B. The End User then selects End User at step and display B, and the method moves to step and display D. At step and display D, the End User enters the door number and identifies whether door passed or failed the daily test. If Passed is selected in step D, the method proceeds to step and display M which asks the end user to verify they are recording that the door passed the daily safety check or test. If No Go Back is selected the method will return to step and display D. If Yes is selected in step M, the method proceeds to step and display E, and then step N, the end users indicates the responses has been stored locally or remotely.

If Failed is selected at step and display D, the method proceeds to step and display F, asking end user to confirm the door failed, and if Yes is selected in step F, the method proceeds to step and display G which displays an alert, which is then in stored remotely or locally at step N. If No is selected at either step and display F or of M, the method returns to step D to confirm entry or a Passed or Failed selection.

FIG. 22b illustrates a flowchart of steps and displays of a software application for a mobile smartphone being used by a Service Tech or door professional in an annual inspection of an automated door in accordance with a method of the present invention. Beginning at step and display A, a door service company technician performs a professional inspection. The service technician touches the Start icon on the smartphone which starts the program and moves the method to step and display B to select Service Tech, End User or not Sure. Not sure moves the method to step and display C which describes the difference between Service Tech and End User, then touching the screen returns the method to step and display B.

At step and display B the Service Technician selects Service Tech, moving the method to step and display H where the service technician enters his or her AAADM certification number or name and company name. The method then proceeds to step and display I, where the service technician enters the test door number and identifies whether the door Passed, or Failed, or Passed with Repairs. If door Passed or Passed with Repairs is selected, the method moves to step and display M which asks to confirm the service technician is recording that the door passed the professional inspection, and selecting No return the method to step and display I. If Service Technician selects Yes in step M, the method proceeds to step and display K or L, depending upon whether Passed or Passed with Repair Selected, indicated door has passed or passed with repairs. And step N indicates responses have been stored locally or remotely.

If Failed is selected at step and display I, the method proceeds to step and display F, which asks to select Yes or No to confirm Failed is correct selection. If No is selected, the method returns to step and display I. If Yes is selected in step F, the method proceeds to step and display J indicating an alert that the door has failed annual or scheduled professional inspection, and request you to turn off door until repairs are completed and inspection has passed. The method then proceeds to step N to indicate the responses have been stored locally or remotely.

1. A method for recording safety inspections of an automated door, said method comprising the steps of:
performing a safety inspection of an automated door;
entering identifying door information and safety inspection data on a wireless transmitting device;
transmitting the identifying door information and the safety inspection data from the wireless transmitting device to an electronic storage device; and
recording the identifying door information and safety the inspection data in the electronic storage device.
